(19) United States
(12) Patent Application Publication
(10) Pub. No.: US 2016/0124861 A1
(43) Pub. Date: May 5, 2016

(54) CACHE MEMORY AND METHOD FOR ACCESSING CACHE MEMORY

(71) Applicant: FUJITSU LIMITED, Kawasaki-shi (JP)

(72) Inventors: MASATOSHI FUJII, Kawasaki (JP); Hisashi Hinohara, Shinagawa (JP); YASUHIRO YUBA, KASHIWA (JP)

(21) Appl. No.: 14/877,011

(22) Filed: Oct. 7, 2015

(30) Foreign Application Priority Data
Oct. 31, 2014 (JP) 2014-223770

(51) Int. Cl. G06F 12/08

(52) U.S. Cl. CPC G06F 12/0895; G06F 12/0891; G06F 2212/60

(57) ABSTRACT

A cache memory is equipped with a cache memory area, a conversion information storing unit, and a conversion circuit. In the cache memory area, a plurality of sets are divided into a plurality of sectors. The conversion information storing unit stores, for each of the plurality of sectors, conversion information for converting a relative set index in a sector into a set index in the cache memory area. The conversion circuit converts the relative set index in the sector indicated by the sector identification information to a set index that indicates a set accessed by the processor in the cache memory area, using sector identification information that identifies an access-target sector and the conversion information stored in the conversion information storing unit.

### CROSS-REFERENCE TO RELATED APPLICATIONS

This application is based upon and claims the benefit of priority of the prior Japanese Patent Application No. 2014-223770, filed on Oct. 31, 2014, the entire contents of which are incorporated herein by reference.

### FIELD

The embodiments discussed herein are related to control of a cache memory.

### BACKGROUND

As a method for an efficient use of a cache memory, a method has been known in which a cache memory area to be used by a processor is divided into a plurality of divided areas which each include at least one cache way. Then, the processor may specify and use one of divided area that is divided in the cache memory area when performing processes such as cache clear, pre-fetch, data storage, and the like. Accordingly, it becomes possible to use each divided area in the cache memory in different ways depending on the purpose.

FIG. 1 illustrates an example of a method for using a cache memory. FIG. 1 presents an example of a cache memory area 110 in a cache memory. Each box in the cache memory area 110 represents a cache line. The cache memory area 110 includes a plurality of sets (for example, 4096 sets), and each set includes a plurality of cache lines (for example, five lines). Each of the plurality of cache lines included in one set belongs to a cache way that is different from the others. In FIG. 1, each set is presented in one line, and each cache way is presented in one column.

Each cache line is assigned a number 1 through 3. The number 1 through 3 is a management identification number for the management of the cache lines. As a method for using a cache memory, FIG. 1 illustrates as an example a method in which the management identification number 1 is assigned to two cache ways, the management identification number 2 is assigned to one cache way, and the management identification number 3 is assigned to two cache ways. The assignment is made such that, for example, the management identification number #1 is assigned to a way #0 and a way #1 of a set #1, the management identification number 3 is assigned to a way #2 and a way #3 of the set #1, and the management identification number 2 is assigned to a way #4 of the set #1. Accordingly, it becomes possible to manage the entirety of the cache memory area 110 with categorization into a plurality of divided areas that are identified by a plurality of management identification numbers. Meanwhile, the size of each of the plurality of divided area is a multiple of the size of the cache way. According to the example in FIG. 1, each of the divided areas in the cache memory area may be used in different ways depending on the purpose.

As a method for managing a cache memory, a method has been known in which a cache memory is controlled from a program (for example, see Patent Document 1).

Japanese Laid-open Patent Publication No. 2009-163450

### SUMMARY

A cache memory is equipped with a cache memory area, a conversion information storing unit, and a conversion circuit. In the cache memory area, a plurality of sets are divided into a plurality of sectors. The conversion information storing unit stores, for each of the plurality of sectors, conversion information for converting a relative set index in a sector into a set index in the cache memory area. The conversion circuit converts the relative set index in the sector indicated by the sector identification information to a set index that indicates a set accessed by the processor in the cache memory area, using sector identification information that identifies an access-target sector and the conversion information stored in the conversion information storing unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a method for using a cache memory;

FIG. 2 illustrates a functional configuration example of a cache memory according to the embodiment;

FIG. 3 illustrates an example of address information according to the embodiment;

FIG. 4 illustrates an example of conversion information (1).

FIG. 5 presents an example (1) of circuits that constitute a cache memory;

FIG. 6 illustrates an example of a method for using a cache memory area;

FIG. 7 illustrates an example of conversion information (2).

FIG. 8 presents an example (2) of circuits that constitute a cache memory;

FIG. 9 illustrates an example of a method for putting unallocated areas together;

FIG. 10 illustrates an example of unallocated area information and unallocated area count information;

FIG. 11 illustrates an example of a sector acquisition process;

FIG. 12 illustrates an example of a sector release process;

FIG. 13 illustrates a process for putting unallocated areas together;

FIG. 14 is a flowchart illustrating an example (1) of a sector acquisition process;

FIG. 15 is a flowchart illustrating an example (2) of a sector acquisition process;

FIG. 16 is a flowchart illustrating an example (1) of a sector release process;

FIG. 17 is a flowchart illustrating an example (2) of a sector release process; and

FIG. 18 is a flowchart illustrating a process for putting unallocated areas together.

### DESCRIPTION OF EMBODIMENTS

When a cache memory is used in a process for a certain purpose, the total size of data used for the process may be smaller than the size of one cache way. When data of a size that is smaller than the size of the cache way are used, it is a waste to allocate for this purpose an area having a size that is equal to or larger than the size of the cache way. Accordingly, there is room for further enhancement of the efficiency of the use in the cache memory.

In an aspect, an objective of the present invention is to reduce the cache memory area in which redundant allocation is performed.

Hereinafter, the embodiment is explained in detail with reference to the drawings.

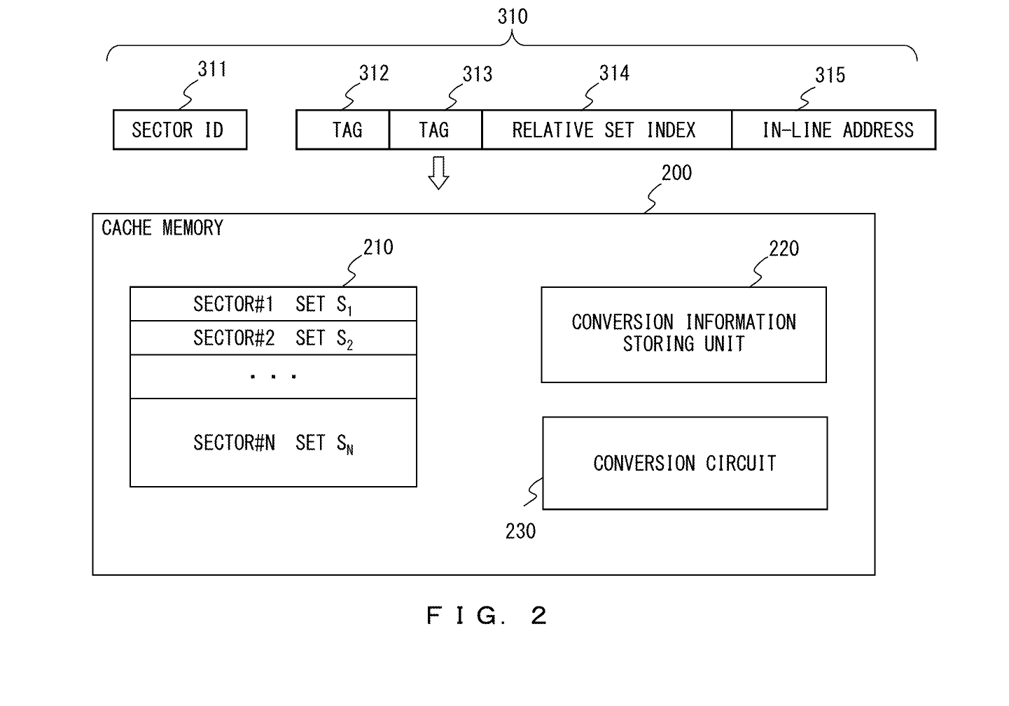

FIG. 2 illustrates a functional configuration example of a cache memory according to the present embodiment. A cache memory 200 is equipped with a cache memory area 210, a conversion information storing unit 220, and a conversion circuit 230.

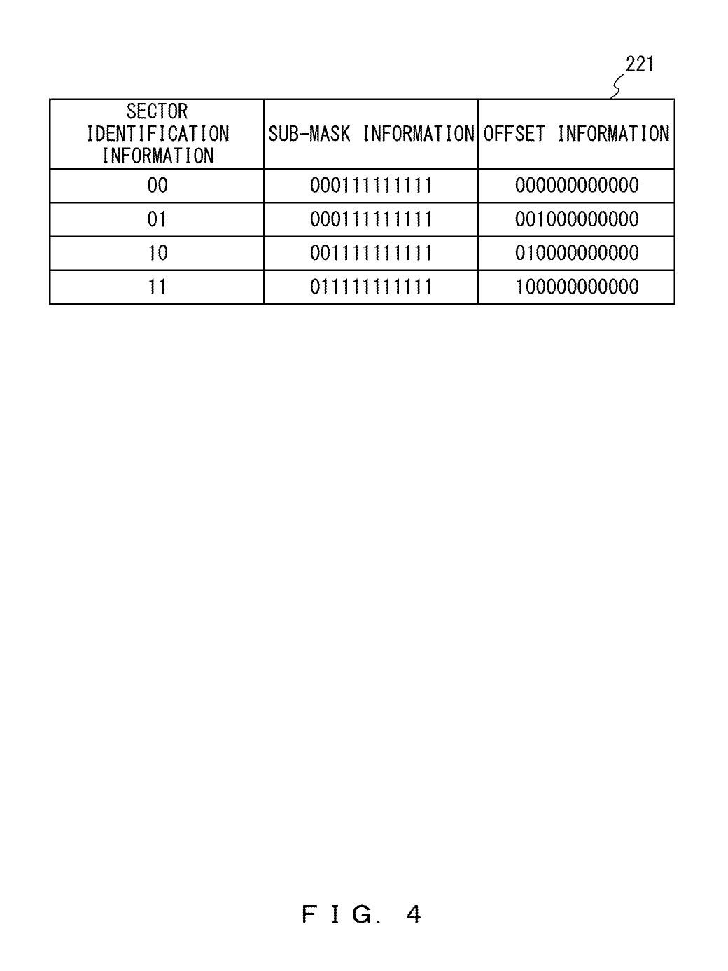

The cache memory area 210 includes a plurality of sets, and each set includes at least one cache line. When a plurality of cache lines are included in a set, each cache line belongs to a different cache way. In the cache memory area 210, a plurality of sets to be used are divided into a plurality of areas. Hereinafter, each of the divided areas of the cache memory area 210 is referred to as a “sector”. That is, a plurality of sets are grouped into a plurality of sectors. Each sector in the cache memory area 210 includes at least one set. In the example in FIG. 2, the cache memory area 210 is provided with a sector #1 through a sector #N. The sector #1 includes S₁ sets. The sector #2 includes S₂ sets. In addition, the sector #N includes S_{N} sets. It is preferable that the number of sets in each sector indicated as S₁ through S_{N} be a power of 2, for example. This is because, as is understood from the explanation for FIG. 4-8 provided later, when the number of sectors is a power of 2, it is possible to efficiently use the entirety of the cache memory area 210, and also, the conversion circuit 230 may be configured in a simple manner.

The conversion information storing unit 220 stores conversion information corresponding to each of the plurality of sectors. The conversion information is information for converting a relative set index in a sector into a set index in the cache memory area 210 (that is, an absolute index in the cache memory area 210) as a whole. Specifically, the relative set index in a sector is included in address information 310.

The address information 310 is included in a request for an access (for example a load instruction, a store instruction, or the like) from a processor (more specifically, an instruction execution circuit in the processor core) to the main storage apparatus. More specifically, the address information 310 according to the present embodiment includes a sector identification information (sector ID) 311, a tag 312, a tag 313, a relative set index 314, and an in-line address 315. “ID” in the sector ID is an abbreviation of identification. The combination of the tag 312, the tag 313, the relative set index 314, and the in-line address 315 indicates the address of the main storage apparatus. The sector identification information 311 is not used in the access to the main storage apparatus.

The sector identification information 311 is unique information used for identifying a sector. The sector identification information 311 identifies an access-target sector in the sector #1 through the sector #N. The tag 312 and the tag 313 are a tag used when a search for a cache line is performed in the set that is the target of the access from the processor (more specifically, the instruction execution circuit). The relative set index 314 is an index that indicates the access-target set, and specifically, it indicates where the access-target set is, counting from the first set of the sector indicated by the sector identification information 311. The in-line address 315 is the address of the access-target data in the cache line. The in-line address 315 identifies data in the cache line.

The conversion information storing unit 220 stores conversion information corresponding to the sector #1 through the sector #N. The conversion information may include the first set index of each sector.

The conversion circuit 230 converts the relative set index 314 in the sector indicated by the sector identification information 311 into the index that indicates a set in the cache memory area 210 accessed by the processor, using the sector identification information 311 and the conversion information. More specifically, from the sector identification information 311 and conversion information, the conversion circuit 230 obtains the first set index that indicates the first set of the sector target of the access from the processor. The conversion circuit 230 combines the relative set index 314 and the first set index, to convert the relative set index 314 into a set index that indicates a set in the cache memory 210 accessed by the processor. By this process, the set index that indicates the access-target set in the cache memory area 210 is identified.

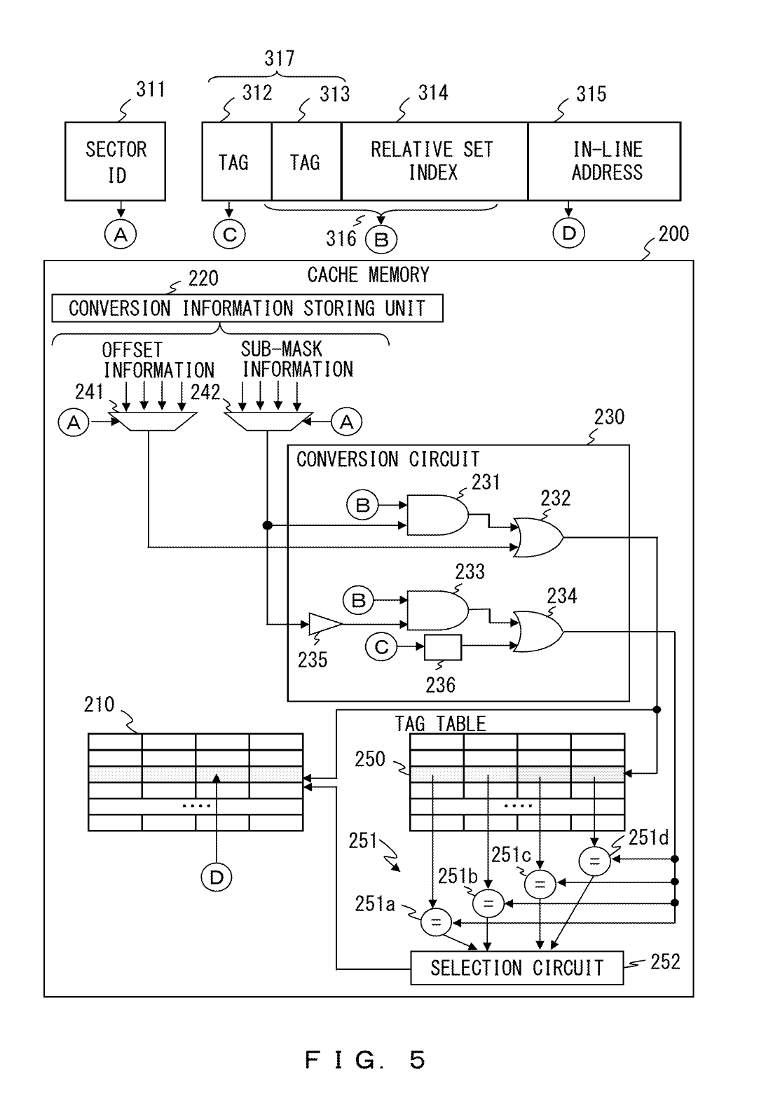

Incidentally, the cache memory 200 may further include a tag information storing unit (a tag array) and a comparator circuit that are not illustrated in FIG. 2. A tag table 250 is presented in FIG. 5 explained later as an example of the tag information storing unit, and comparators 251a through 251d are illustrated as an example of the comparator circuit. By providing the tag information storing unit and the comparator circuit, the division into a plurality of sectors becomes possible not only in a direct-mapped cache memory but also in a set-associative cache memory.

The tag information storing unit stores first tag information with respect to the cache memory area 210. Specifically, the first tag information includes one or more tags that identify a cache line in an individual set. Hereinafter, for the sake of convenience of explanation, the portion of the address of the main storage apparatus other than the relative set index 314 and the in-line address 315 (that is, the combination of the tag 312 and the tag 313) may also be referred to as second tag information. The comparator circuit compares the second tag information with the first tag information. According to the comparison result, an access is made to the appropriate cache line. Specifically, an access is made to data indicated by the in-line address 315 in the cache line indicated by the tag that matches the second tag information, in the set identified by the set index obtained by the conversion circuit 230.

Specifically, the second tag information may be input from the conversion circuit 230 to the comparator circuit. Specifically, the conversion circuit 230 may extract the second tag information (that is, the combination of the tag 312 and the tag 313) that is the portion of the address information 310 without the relative set index 314 and the in-line address 315. Then, the conversion circuit 230 may output the extracted second tag information to the comparator circuit.

Here, the size of the tag 312, the size of the portion in which the tag 313 and the relative set index 314 are combined, and the size of the in-line address 315 in the address information 310 are determined in advance. The size of the relative set index 314 maybe arbitrarily decided for each sector. Then, the size of the tag 313 is variable according to the size of the relative set index 314.

While the number of sets included in the cache memory area 210 may be any number, the number of sets is supposed to be sufficiently large compared with the number of cache ways. Therefore, by dividing the cache memory area 210 in units of sets as illustrated in FIG. 2, it becomes possible to divide the cache memory area 210 into areas that are smaller than in the case of division in units of cache ways. That is, according to the present embodiment, it becomes possible to divide the cache memory smaller. Accordingly, when using the cache memory area 210 in cache clear, pre-fetch, data storage processes and the like, it becomes possible to use the cache memory area 210 in units of sets whose capacity is smaller than that in units of cache ways. As a result, it becomes possible to use the cache memory area 210 more efficiently.

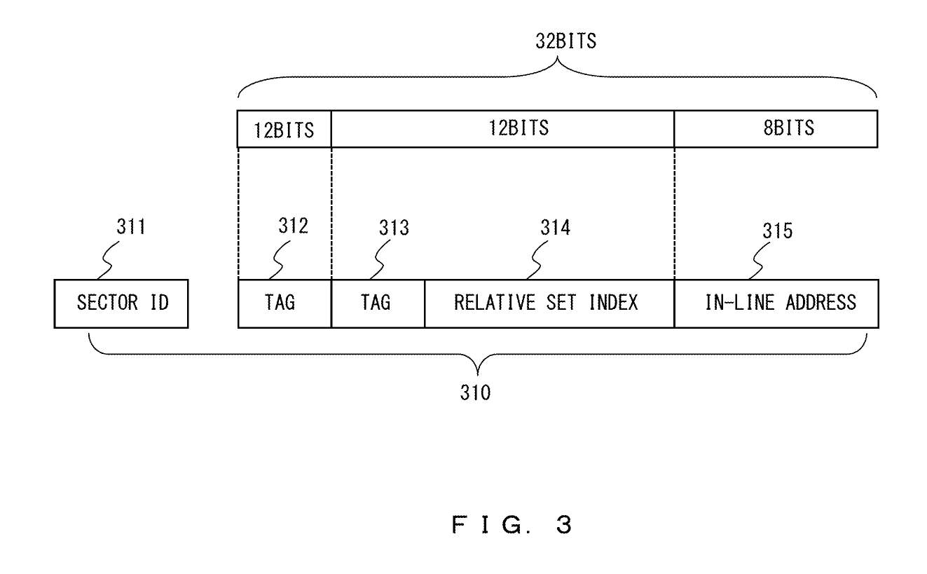

FIG. 3 illustrates an example of the address information according to the present embodiment. Hereinafter, the address space of the address that is used when the processor accesses the main storage apparatus is assumed to be a space expressed in 32 bits, for example. In addition, it is assumed that, in the cache memory area 210, the number of sets is 4096(=2¹²), and the cache line size is 256(=2⁸) bytes. Meanwhile, the address information is expressed in binary notation.

Then, the size of the in-line address 315 is 8 bits, according to the cache line size 256(=2⁸) bytes. In addition, one set included in the 4096 sets may be identified by using a 12-bit set index. In the present embodiment, the tag 313 and the relative set index 314 are used instead of a 12-bit set index. Meanwhile, the length of the portion of the combination of the tag 313 and the relative set index 314 is 12 bits, and the size of the address space represented by this portion is 4096. In the 32 bits, the remaining 12 bits are used for the tag 312.

The address space represented by the portion of the combination of the tag 313 and the relative set index 314 is expressed in a fixed bit count of 12 bits, but the number of bits that expresses the relative set index 314 differs depending on the number of sets included in the access target. For example, when the cache memory area 210 is divided into several sectors and the access-target sector includes 1024(=2¹⁰) sets, the relative set index 314 uses 10 bits. Accordingly, the tag 313 uses the remaining 2 bits.

FIG. 4 illustrates an example (1) of the conversion information. The conversion information is information for converting the relative set index in a sector into the set index in the cache memory area 210. Sector identification information included in conversion information 221 is unique information used for identifying a sector. An example of conversion information 221 includes sector identification information “00” through “11” corresponding to the sector #1 through the sector #4. Meanwhile, in the example in FIG. 4, it is assumed that the sector #1 identified by the sector identification information “00” includes sets from the first set to the 512th set of the cache memory area 210. It is assumed that the sector #2 identified by the sector identification information “01” includes 512 sets from the set following the sets included in the sector #1. It is assumed that the sector #3 identified by the sector identification information “10” includes 1024 sets from the set following the sets included in the sector #2. It is assumed that the sector #4 identified by the sector identification information “11” includes 2048 sets from the set following the sets included in the sector #3. The conversion information 221 includes sub-mask information and offset information corresponding to each sector identification information.

The sub-mask information is used for extracting the relative set index 314 from the tag 313 and the relative set index 314 included in the address information 310. The sub-mask information is 12-bit information in which the digit portion that indicates the relative set index 314 in the tag 313 and the relative set index 314 included in the 12 digits (12 bits) is made significant. The sector #1 and the sector #2 are a sector that include 512 sets, and therefore, the relative set index 314 for the sector #1 and the sector #2 is expressed by 9-digit (9-bit) information. That is, in the 12-digit information including the tag 313 and the relative set index 314, the lower 9 digits correspond to the relative set index 314. Accordingly, 1 is set in the lower 9 digits in the 12 digits of the sub-mask information corresponding to the sector #1 and the sector #2. Meanwhile, in the 12 digits of the sub-mask information corresponding to the sector #3, 1 is set in the lower 10 digits, and, in the 12 digits of the sub-mask information corresponding to the sector #4, 1 is set in the lower 11 digits. It becomes possible to extract the relative set index 314 by getting AND of the sub-mask information and the 12-digit information of the tag 313 and the relative set index 314.

The offset information is used for obtaining the set index in the cache memory area 210 from the relative set index 314. The relative set index 314 indicates where the access-target set is, counted from the first set of each sector. The offset information is 12-bit information that indicates the set index of the first set of each sector. For example, the first set of the sector #2 is the set #512, and therefore, the offset information is (001000000000) in binary notation. The set index in the cache memory area 210 may be obtained by getting OR of the obtained relative set index 314 and the offset information.

FIG. 5 illustrates an example (1) of circuits that constitute a cache memory. A cache memory 200 is equipped with a cache memory area 210, a multiplexer 241, a multiplexer 242, a conversion information storing unit 220, a conversion circuit 230, a tag table 250, comparators 251a through 251d, and a selection circuit 252. In the cache memory 200 in FIG. 5, the same numerals are assigned to the same constituent elements as those in FIG. 2. In addition, the comparators 251a through 251d are collectively referred to as the “comparator 251”.

The cache memory area 210 and the conversion information storing unit 220 may be realized by an SRAM (Static Random Access Memory), for example. In a case in which the conversion information storing unit 220 is realized by a volatile memory such as an SRAM, when electric power is supplied to the cache memory 200, conversion information is read from the volatile memory (not illustrated in the drawing) that stores conversion information, and the conversion information is written into the conversion information storing unit 220. The tag table 250 may be realized by a CAM (Content Addressable Memory), for example.

When a processor (specifically, an instruction execution circuit) attempts to execute an instruction that involves an access to the main storage apparatus, the address information 310 included in the instruction is input to the cache memory 200. Then, the conversion information stored in the conversion information storing unit 220 is read, according to the sector identification information 311 included in the address information 310. The conversion information to be read is the offset information and the sub-mask information. Input to the multiplexer 241 are the respective offset information and the sector identification information 311 stored in the conversion information storing unit 220. The multiplexer 241 selects offset information that corresponds to the input sector identification information 311 and outputs the selected offset information to the conversion circuit 230. Input to the multiplexer 242 are the respective sub-mask information and the sector identification information 311. The multiplexer 242 selects sub-mask information that corresponds to the input sector identification information 311 and outputs the selected sub-mask information to the conversion circuit 230.

The conversion circuit 230 is equipped with an AND circuit 231, an OR circuit 232, an AND circuit 233, an OR circuit 234, a NOT circuit 235, and a bit shift circuit 236. The AND circuit 231 and the OR circuit 232 are used for identifying, from the address information 310, the set index that indicates the access-target set in the cache memory area 210.

The AND circuit 231 performs AND of the sub-mask information output from the multiplexer 242 and 12-bit data 316 that include the tag 313 and the relative set index 314. The AND circuit 231 outputs, to the OR circuit 232, the relative set index 314 extracted from the 12-bit data 316 as a result of AND. More precisely, the AND circuit 231 outputs, to the OR circuit 232, the relative set index 314 that is expressed in 12 bits with the high-order bits being appropriately padded with “0”.

The OR circuit 232 performs OR of the offset information output from the multiplexer 241 and the relative set index 314 extracted by the AND circuit 231. The OR circuit 232 outputs, as a result of OR, the set index that indicates the access-target set in the cache memory area 210. As described above, when the conversion information 221 includes the first set index of each sector (that is, the offset information for each sector), it becomes possible to convert the relative set index 314 into the absolute set index using a simple circuit such as the OR circuit 232.

The NOT circuit 235 inverts each bit of the sub-mask information output from the multiplexer 242. That is, the NOT circuit 235 converts “0” to “1” and converts “1” to “0”. The NOT circuit 235 outputs the information in which “0” and “1” in the sub-mask information are inverted, to the AND circuit 233. In the information in which “0” and “1” in the sub-mask information are inverted, the portions of bits in the 12 bits of the sub-mask information that correspond to the tag 313 are “1”, and the remaining portions are “0”.

The AND circuit 233 performs AND of the information output from the NOT circuit 235 and the 12-bit data 316 that includes the tag 313 and the relative set index 314. The

AND circuit 233 outputs, to the OR circuit 234, the tag 313 extracted from the 12-bit data 316 as a result of AND. More precisely, the AND circuit 233 outputs, to the OR circuit 234, the tag 313 that is expressed in 12 bits with the low-order bits being appropriately padded with “0”.

The bit shift circuit 236 performs, when the tag 312 is input, a bit shift in order to add 12 bits corresponding to the bit count of the tag 313 and the relative set index 314 to the bit count of the tag 312. As a result of the bit shift, 12 bits of “0” are added to the end of the tag 312, and 24-bit result information is obtained.

The OR circuit 234 performs OR of the result information of the bit shift output from the bit shift circuit 236 and the tag 313 extracted by the AND circuit 233. More specifically, the OR circuit 234 performs OR of the 24-bit result information output from the bit shift circuit 236 and 24-bit information in which 12 bits of “0” are connected in front of the tag 313 that is expressed in 12 bits with the low-order bits being appropriately padded with “0”. The OR circuit 234 outputs a tag 317 in which the tag 312 and the tag 313 are connected, as a result of OR. More precisely, the OR circuit 234 outputs the tag 317 that is expressed in 24 bits with the low-order bits being appropriately padded with 0.

The tag table 250 stores tag information corresponding to each set of the cache memory area 210. Tag information corresponding to one set includes a plurality of tags, and each tag is expressed in 24 bits. As mentioned earlier, the tag table 250 may be realized by a CAM, for example. Therefore, according to the output of the set index from the OR circuit 232 to the tag table 250, tag information that corresponds to the set identified by the output set index is output from the tag table 250 to the comparator 251.

Therefore, the comparator 251 is able to read, from the tag table 250, the tag information that corresponds to the set identified by the set index obtained by the OR circuit 232. The comparators 251 are provided in the same number as the number of tags stored in the tag table 250. That is, the number of the comparators 251 is equal to the number of cache lines included in one set of the cache memory area 210, and in other words, it is equal to the number of cache ways. One comparator 251 reads one tag corresponding to this comparator 251 in the plurality of tags included in the tag information. Each comparator 251 (that is, each of the comparators 251a through 251d) determines whether the tag obtained from the tag table 250 and the tag 317 output from the OR circuit 234 match.

The selection circuit 252 receives a determination result from each comparator 251 (each of the comparator 251a through the comparator 251d). The selection circuit 252 outputs a selection signal for selecting one cache line from the set identified by the set index output from the OR circuit 232, according to the received determination result. In other words, the selection circuit 252 outputs a selection signal for specifying a cache way.

In the example in FIG. 5, it is assumed that the tag in the tag table 250 and the tag 317 output to the comparator 251c match. Accordingly, the access-target cache line in the cache memory area 210 is identified as the third cache line from the left. In addition, in the example in FIG. 5, it is assumed that the access-target set that is identified by the set index output from the OR circuit 232 is the third set from the beginning of the cache memory area 210. The processor (specifically, the instruction execution circuit) accesses the in-line address 315 of the third cache line from the left identified as described above in the third set from the beginning. Meanwhile, when a cache miss occurs, the cache memory 200 performs a refill process for a cache line with fewer accesses using an algorithm such as Least Recently Used (LRU).

By using the circuits of the cache memory 200 in FIG. 5, it becomes possible to divide the cache memory area 210 to be used in units of sets. The number of sets included in the cache memory area 210 maybe any number, but the number of sets is supposed to be sufficiently large compared with the number of cache ways. Therefore, by dividing the cache memory area 210 in units of sets, it becomes possible to divide the cache memory area 210 into areas that are smaller than in the case of division in units of cache ways. That is, according to the present embodiment, it becomes possible to divide the cache memory smaller. Accordingly, when using the cache memory area 210 in cache clear, pre-fetch, data storage processes and the like, it becomes possible to use the cache memory area 210 in units of sets whose capacity is smaller than that in units of cache ways. As a result, it becomes possible to use the cache memory area 210 more efficiently.

### <Method for Using Nonconsecutive Sets as a Sector>

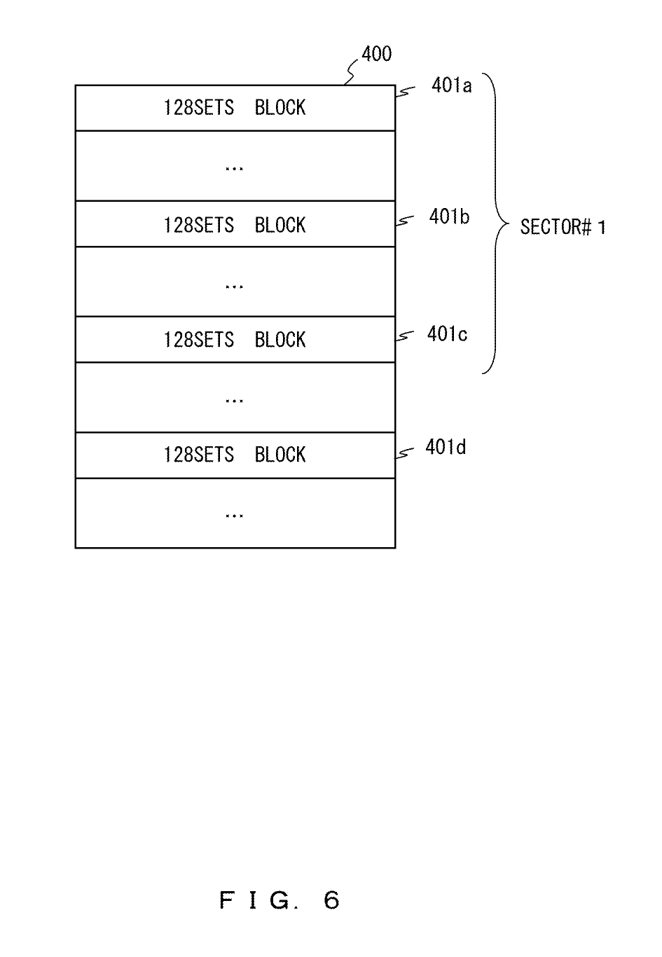

FIG. 6 illustrates an example of a method for using the cache memory area. A method for using the cache memory area in which nonconsecutive sets are used as one sector is explained below. A cache memory area 400 includes blocks 401a through 401d. Hereinafter, the blocks 401a through 401d may be referred to as the “block 401” without distinction. The blocks 401a through 401d are arranged not in a consecutive manner but in a nonconsecutive manner. In the cache memory area 400 according to the present embodiment, four blocks 401 (the blocks 401a through 401d) are used as one sector. When the cache memory area includes a plurality of sectors, each sector to be used is divided into the same number of blocks (for example, four blocks). Meanwhile, it is assumed that the number of divisions for each sector is determined in advance. As described in detail later, it is possible for two or more blocks in a prescribed number of divided blocks to be arranged in a consecutive manner. Each sector includes power-of-2 pieces of blocks and satisfies a condition (referred to as an alignment condition) that each sector always starts from the address position that is a multiple of the number of sets of the area. The alignment condition is a constraint imposed in order to efficiently allocate sets to sectors. Each block 401 (each of the blocks 401a through 401d) of a sector that includes 512 sets includes 128 sets.

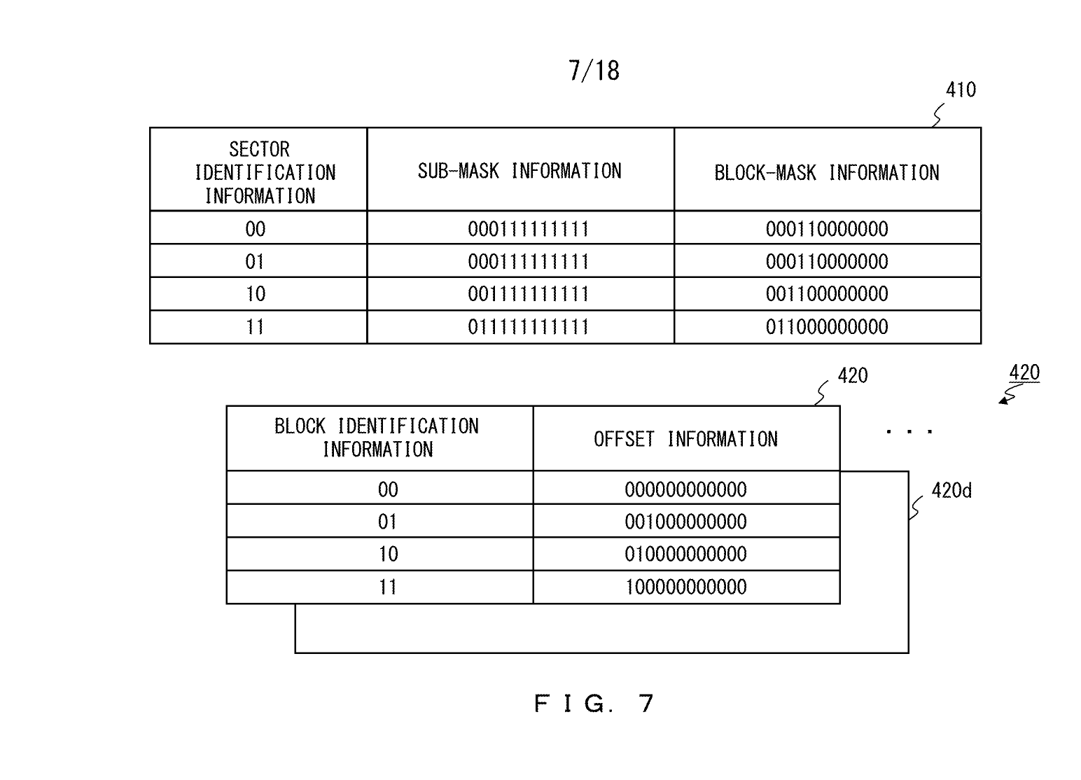

FIG. 7 illustrates an example (2) of the conversion information. Conversion information 410 and conversion information 420 are information for converting the relative index in a sector into a set index in the cache memory area 400. An example of the conversion information 410 includes sector identification information “00” through “11” corresponding to a sector #1 through a sector #4.

Meanwhile, in the example in FIG. 7, it is assumed that each of the sector #1 and the sector #2 identified by the sector identification information “00” and “01”, respectively, includes 512 sets in the cache memory area 400. It is assumed that the sector #3 identified by the sector identification information “10” includes 1024 sets in the cache memory area 400. It is assumed that the sector #4 identified by the sector identification information “11” includes 2048 sets in the cache memory area 400.

The conversion information 410 includes sub-mask information and block-mask information corresponding to each piece of sector identification information. While the sector identification information in FIG. 7 is expressed by 2-bit information, the sector identification information may be different information that has a longer bit length, as long as each sector may be identified by the information.

The sub-mask information is used for extracting the relative set index 314 from the combination of the tag 313 and the relative set index 314 included in the address information 310. The sub-mask information is 12-bit information in which the digit portion that indicates the relative set index 314 in the combination of the tag 313 and the relative set index 314 included in the 12 digits (12 bits) is made significant. The sector #1 and the sector #2 are a sector that includes 512 sets, and therefore, the relative set index 314 for the sector #1 and the sector #2 is expressed by 9-digit (9-bit) information. That is, in the 12-digit information of the tag 313 and the relative set index 314, the lower 9 digits correspond to the relative set index 314. Accordingly, 1 is set in the lower 9 digits in the 12 digits of the sub-mask information corresponding to the sector #1 and the sector #2. Meanwhile, in the 12 digits of the sub-mask information corresponding to the sector #3, 1 is set in the lower 10 digits, and, in the 12 digits of the sub-mask information corresponding to the sector #4, 1 is set in the lower 11 digits. It becomes possible to extract the relative set index 314 by performing AND of the sub-mask information and the 12-digit information of the tag 313 and the relative set index 314.

The block-mask information is 12-digit (12-bit) information including information that indicates the number of divided blocks in a sector. It becomes possible to extract block identification information that indicates the block 401 that is the access target, by performing AND of the block-mask information and the 12-bit data 316 included in the address information 310 (that is, the portion of the combination of the tag 313 and the relative set index 314). In one sector, each of the block 401a through the block 401d is uniquely identified by the block identification information. For the sector #1 including 512(=2⁹) sets, the tag 313 is 3(=12−9) bits, and the relative set index 314 is 9 bits. Then, in the AND operation, the upper 3 digits of the block-mask information are used for the operation with the tag 313, and the lower 9 digits of the block-mask information are used for the operation with the relative set index 314. In the 9 bits obtained from the AND operation with the relative set index 314, 2 bits correspond to the block identification information.

Hereinafter, the information that indicates the number of divided blocks of the sector may also be referred to as “number of divisions information”. The number of divisions information is a bit pattern that represents the number of divisions. The number of divisions is the same for all sectors.

More specifically, the number of divisions is determined in advance, and it is a power of 2. The number of divisions information is represented by a bit pattern of a length corresponding to the number of divisions. For example, when the number of divisions is 2(=2¹), the number of divisions information is 1-bit “1”. Meanwhile, when the number of divisions is 4(=2²), the number of divisions information is 2-bit “11”. That is, when the number of divisions is 2^{D}, the number of divisions information is a bit pattern in which “1” is lined up in a number corresponding to D (meanwhile, D is a prescribed integer that is 1 or larger). When the number of divisions is 2^{D}, there may be a sector that is divided into 2^{D} blocks, and there may also be a sector that is not divided into blocks. Meanwhile, two or more of the 2^{D} blocks may be successive by chance. That is, there may be a sector that is apparently divided into blocks by a number that is smaller than 2^{D}. A sector that is not divided into blocks may also be regarded as being divided into successive 2^{D} blocks.

In the example in FIG. 7, each of the sector #1 through the sector #4 is divided by 4. Therefore, the number of divisions information for all of the sector #1 through the sector #4 is “11”. In the sector #1, the number of divisions information “11” is set in the first 2 bits of the lower 9 digits of the block-mask information used for the calculation with the relative set index 314. Accordingly, “000110000000” is set in the block-mask information of the sector #1. In the sector #2, the number of divisions information “11” is set in the first 2 bits of the lower 9 digits of the block-mask information used for the calculation with the relative set index 314. Accordingly, “000110000000” is set in the block-mask information of the sector #2. In the sector #3, the number of divisions information “11” is set in the first 2 bits of the lower 10 digits of the block-mask information used for the calculation with the relative set index 314. Accordingly, “001100000000” is set in the block-mask information of the sector #3. In the sector #4, the number of divisions information “11” is set in the first 2 bits of the lower 11 digits of the block-mask information used for the calculation with the relative set index 314. Accordingly, “011000000000” is set in the block-mask information of the sector #4.

As described above, when the number of sets of a certain sector is 2^{M}, and the sector is also divided into 2^{D} blocks, the block-mask information of the sector is 12-bit information in which 0 in a number corresponding to (12-M), “1” in a number corresponding to D, and “0” in a number corresponding to (M-D) are lined up.

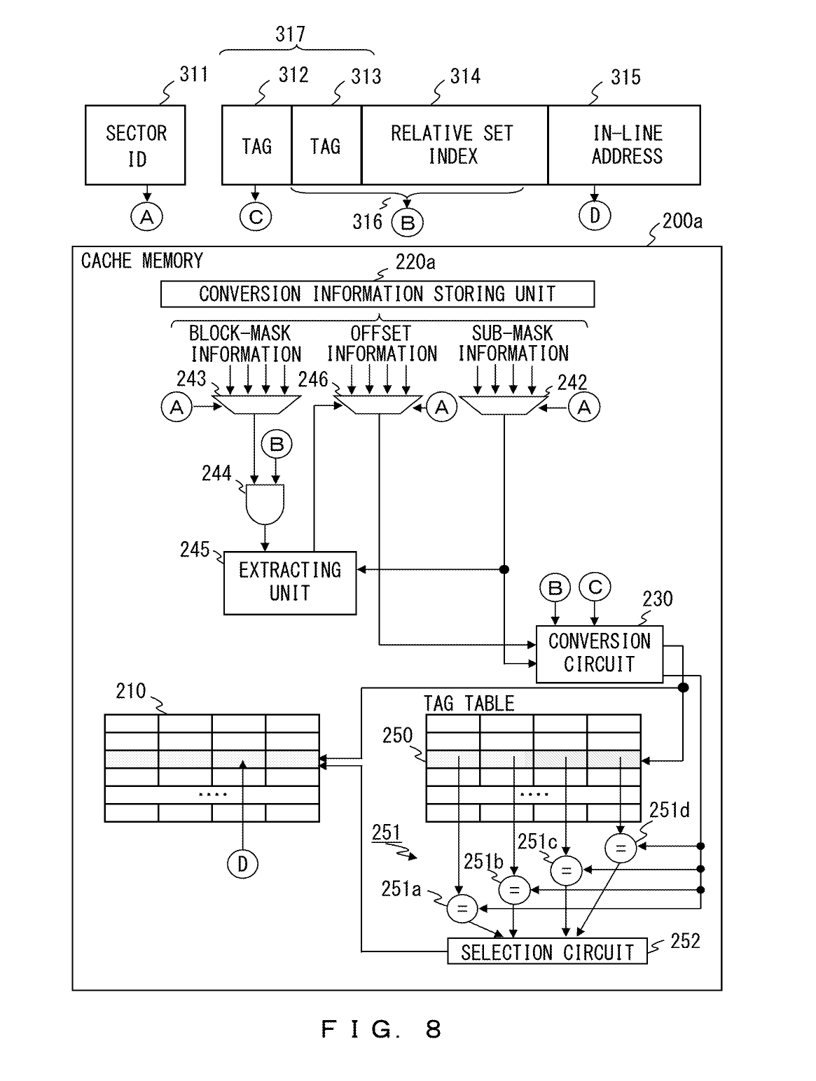

The conversion information 420 includes block identification information and offset information that indicates the set index of the first set of each block. A conversion information storing unit 220a illustrated in FIG. 8 stores the conversion information 420 for each sector. Accordingly, the conversion information storing unit 220a stores the conversion information 420 (the conversion information 420a through 420d) in association with each of the sector identification information “00” through “11” in the conversion information 410. Hereinafter, the conversion information 420a through 420d may be referred to as the “conversion information 420” without distinction.

The block identification information included in the conversion information 420 is information for identifying each block 401 in one sector. When the number of divisions is 2^{D}, the block identification information is expressed in D bits. Meanwhile, as described earlier, the block identification information maybe extracted from the data 316, and offset information corresponding to the extracted block identification information is used. Specifically, the block identification information is obtained by extracting a portion of information from the result of AND of the block-mask information in the conversion information 410 with the tag 313 and the relative set index 314 included in the address information 310. The portion of information extracted from the result of AND is the result of AND with the bit portion (2 bits) that represents the number of divisions information in the block-mask information. More specifically, the portion of information extracted from the result of AND is the result of AND of the bit portion (2 bits) that represents the number of divisions information in the block-mask information and the first 2 bits of the relative set index 314.

The offset information of the block that corresponds to the extracted block identification is selected according to the conversion information 420, and it is provided to the conversion circuit 230. The conversion circuit 230 converts the relative set index 314 into a set index that indicates the set in the cache memory area 400, using the offset information.

FIG. 8 illustrates an example (2) of circuits that constitute a cache memory. In a cache memory 200a in FIG. 8, the same numerals are assigned to the same constituent elements as those in FIG. 5. The cache memory 200a in FIG. 8 is equipped with a conversion information storing unit 220a that stores the conversion information 410 and the conversion information 420 in FIG. 7, instead of the conversion information storing unit 220 in FIG. 7. In addition, the cache memory 200a in FIG. 8 is equipped with a multiplexer 246 instead of the multiplexer 241 in FIG. 5. The cache memory 200a is further equipped with a multiplexer 243, an AND circuit 244, and an extracting unit 245.

Meanwhile, the cache memory area 400 in FIG. 7 is different from the cache memory area 210 in FIG. 2 and FIG. 5 in the method in which it is used (that is, whether or not the sector is divided into a plurality of blocks). However, physically, the cache memory area 400 in FIG. 7 may be the same as the cache memory area 210 in FIG. 2 and FIG. 5. For example, in the same manner as the cache memory area 210 in FIG. 2 and FIG. 5, the cache memory area 400 in FIG. 7 may be realized by an SRAM, and may include 4096 sets. For this reason, in FIG. 8, the reference numeral “210” is assigned to the cache memory area instead of “400”.

When the processor (specifically, the instruction execution circuit) attempts to execute an instruction that involves an access to the main storage apparatus, the address information 310 included in the instruction is input to the cache memory 200a. Then, the conversion information 410 and the conversion information 420 stored in the conversion information storing unit 220a are read, according to the sector identification information 311 included in the address information 310. The conversion information to be read is block-mask information, sub-mask information, and offset information.

Each piece of block-mask information and the sector identification information 311 stored in the conversion information storing unit 220a are input to the multiplexer 243. The multiplexer 243 selects block-mask information that corresponds to the input sector identification information 311 and outputs the selected block-mask information to the AND circuit 244.

The AND circuit 244 performs AND of the block-mask information input from the multiplexer 243 and the 12-bit data 316 including the tag 313 and the relative set index 314.

The extracting unit 245 extracts the block identification information from the result of AND by the AND circuit 244. For example, in the example in FIG. 7, the number of divisions is 4, and therefore, the block identification information is expressed in 2 bits. Therefore, the extracting unit 245 extracts the 2 bits that represent the block identification information from the 12 bits output from the AND circuit 244. Meanwhile, in order to detect the bit position of the beginning of the block identification information in the 12 bits, sub-mask information selected by the multiplexer 242 is input to the extracting unit 245.

Depending on the embodiment, the AND circuit 244 may be included in the extracting unit 245. As illustrated in FIG. 8, when the AND circuit 244 is provided outside the extracting unit 245, the block-mask information selected by the multiplexer 243 may further be input to the extracting unit 245, in order to detect the bit length of the block identification information. However, when the number of divisions is fixed, the bit length of the block-identification is also fixed, and therefore the input of the block-mask information to the extracting unit 245 may be omitted.

In either case, the extracting unit 245 outputs the extracted block identification information to the multiplexer 246.

Offset information stored in the conversion information storing unit 220a, the block identification information output from the extracting unit 245, and the sector identification information 311 are input to the multiplexer 246. The multiplexer 246 selects offset information that corresponds to the input combination of the sector identification information 311 and the block identification information, and outputs the selected offset information to the conversion circuit 230. For example, when the sector identification information 311 is “01” and the block identification information is “10”, the multiplexer 246 outputs the offset information that corresponds to the block identification information “10” in the offset information included in the conversion information 420b.

Physically, the multiplexer 246 may be realized by a plurality of multiplexers. For example, multiplexers that use the sector identification information 311 as the selection signal may be provided in a number that is the same as the number of divisions 2^{D}. In this case, N pieces of offset information corresponding to N blocks identified by the same block identification information in N different sectors are input to each of the 2^{D} multiplexers. Meanwhile, the multiplexer 246 in FIG. 8 is realized by further providing another multiplexer that selects one of the outputs of the 2^{D} multiplexers according to the block identification information.

In the cache memory 200 in FIG. 8, information similar to that in FIG. 5 (that is, the output from the multiplexer 246, the output from the multiplexer 242, the tag 312, and the data 316) is also input to the multiplexer 246. Accordingly, it becomes possible to divide the cache memory area to be used in units of sets, even in a cache memory in which nonconsecutive sets are used as a sector.

According to the present embodiment, it becomes possible to use a plurality of blocks that are arranged in a nonconsecutive manner as one sector. Accordingly, even when the desired number of sets to be used for one sector are not consecutive, it becomes possible to use a sector that includes the desired number of sets. In other words, by using nonconsecutive blocks, it becomes possible to use the cache memory area more efficiently. In addition, by using the conversion information 420 that includes the first set index of each block (that is, the offset information for each block) , it becomes possible to convert the relative set index 314 into an absolute set index.

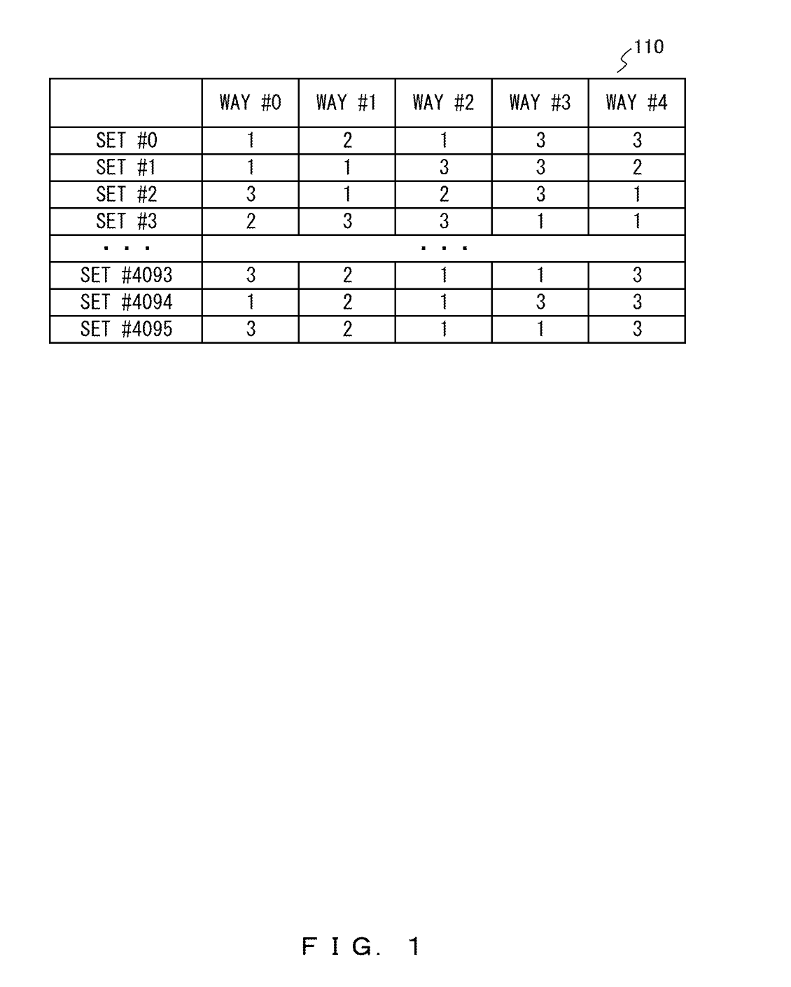

The number of sets in the cache memory area is larger than the number of cache ways. Accordingly, the available number of divisions becomes larger in the case of dividing a plurality of sets into a plurality of sectors in units of sets (see FIG. 2 through FIG. 8 for example) than in the case of dividing a plurality of sets into a plurality of divided areas in units of cache ways (see FIG. 1 for example). Each of the embodiments described above may be applied to both the primary cache (L1 cache) and the secondary cache (L2 cache) . However, a more prominent effect may be obtained by applying each of the embodiments described above to the secondary cache that has a larger number of sets.

The size of each set is equal to the total area size of the cache lines for the number of cache ways. Meanwhile, the size of each cache way is equal to the total area size of the cache lines for the total number of sets. The total number of sets is larger than the number of cache ways, and therefore, the area size of each set is smaller than the size of each cache way. Accordingly, in the case of dividing the cache memory area in units of sets, it becomes possible to use the area in smaller units than by dividing the cache memory area in units of cache ways. That is, according to each of the embodiments described above, it becomes possible to set the size of each sector at a finer grain.

When the cache memory area is divided into a plurality of divided areas in units of cache ways as in FIG. 1 for example, it is not always possible to use all the cache ways in each set. Furthermore, when the cache memory area is divided into a larger number of divided areas, the number of cache ways in one divided area becomes smaller. For this reason, when there are a plurality of cache hits to the same set, there is a possibility of a frequent occurrence of thrashing. On the other hand, in each set in each of the embodiments describe above, all the cache ways included in the cache memory area are available. Accordingly, the frequent occurrence of thrashing may be prevented by dividing the cache memory area in units of sets as in each of the embodiments described above. In each set in each of the embodiments described above, all the cache ways included in the cache memory area are available, and therefore, the cache ways are suitable to be used as a dedicated area for data that tend to be accessed on a concentrated manner.

When securing anew divided area in a cache memory area divided into a plurality of divided areas in units of cache ways, the new divided area is secured by overwriting existing data in all the sets. Therefore, there is a possibility that data in each divided area may be interfered with by a process related to another divided area. Meanwhile, according to the embodiment described above, there is a clear separation between sectors in units of sets. Accordingly, a process for overwriting existing data in a set used for another sector (for example, a process for overwriting the oldest data by an algorithm such as LRU) is never performed along with a process for securing a new sector. Therefore, the sector according to the embodiment described above is suitable to be used as a dedicated area for data that tend to be accessed on a concentrated manner.

Depending on the purpose of use of the cache memory area, it may be desirable to save the cache data. When the cache memory area is divided in units of cache ways, there is a possibility that the data to be saved will be stored in a distributed manner in all the data sectors. Accordingly, when it is desirable to save data in a certain divided area, a process is performed for a full search in the entire cache memory area. Furthermore, even in the middle of execution of the search, a cache line may be updated. On the other hand, in each of the embodiments described above, a data area is stored in consecutive sets in a sector or a block. Accordingly, the storage position of the cache data to be saved (that is, the range of the sets in which cache data to be saved are stored) is easily identified from the conversion information. In addition, by prohibiting only the access to the sets in the identified range, it becomes possible to prevent the cache data to be saved from being updated during execution of the saving process. Therefore, the cache data may be saved relatively easily.

In a comparison example in which the cache memory is divided into a plurality of divided areas in units cache ways as in FIG. 1 for example, the cache memory is equipped with a management circuit and an SRAM for management. The management circuit is a circuit for dividing the cache memory area in units of cache ways and for managing each cache way. The SRAM for management stores identification information for the cache way to which each set belongs, and the like. Meanwhile, the larger the number of the cache ways, the larger the scale of the SRAM and the management circuit. In this regard, according to each of the embodiments described above, it becomes possible to divide the cache memory area into a plurality of sectors by having a small number of AND circuits and OR circuits, a storing unit for storing a small amount of conversion information, and the like. In addition, according to each of the embodiments described above, even when the number of divisions increases, the circuit scale does not expand that much.

### <Cache Memory Control Program>

When various programs are executed in the processor, a portion of the area of the cache memory area is allocated to data used by each program. The size of the area allocated to the data used by the program may vary, ranging from a small area to a large area. In order to handle allocation of areas of various sizes from a small area to a large area, it is desirable that there be an area in which no data are stored and there be a large number of consecutive sets. Hereinafter, an area in which no data are stored and a plurality of consecutive sets are included is referred to as an “unallocated area”.

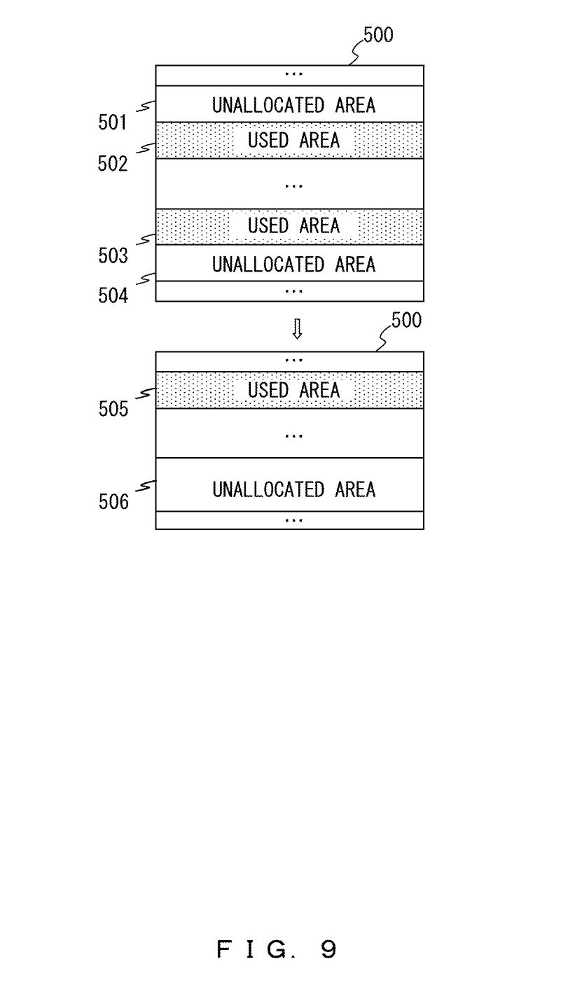

FIG. 9 illustrates an example of a method for putting unallocated areas together. A cache memory area 500 in FIG. 9 includes an unallocated area 501, a used area 502, a used area 503, and an unallocated area 504. The unallocated area 501, the used area 502, the used area 503, and the unallocated area 504 are blocks of the same size (number of sets). The unallocated area 501 and the unallocated area 504 are areas that include only the sets in which no data are stored. The used area 502 and the used area 503 are areas that include a set in which data are stored. It is assumed that each of the unallocated area 501, the used area 502, the used area 503, and the unallocated area 504 is an area that includes X sets. Meanwhile, the unallocated area 501 and the used area 502 are placed in a consecutive manner. In addition, it is assumed that the unallocated area 501 starts from an address that is a multiple of 2X, and the end of the used area 502 is an address that is a multiple of 2X. The used area 503 and the unallocated area 504 are placed in a consecutive manner. In addition, it is assumed that the used area 503 starts from an address that is a multiple of 2X, and the end of the unallocated area 504 is an address that is a multiple of 2X. When two or more unallocated areas which each include X pieces of sets and two or more used areas do not exist on the cache memory area 500, the process for putting unallocated areas together is not performed.

The process for putting unallocated areas together is controlled by a control unit that operates on the Operating System (OS). The control unit is realized by the execution of a program by a processor (specifically, an instruction execution circuit). The program module that realizes the control unit is a part of the OS.

The control unit first copies data in the used area 503 into the unallocated area 501. When the copying of data in the used area 503 is completed, the control unit changes offset information corresponding to the used area 503 in the conversion information 420. The offset information after the change is equal to the set index of the first set of the unallocated area 501. This creates a used area 505 that includes 2X sets and an unused area 506 that includes 2X sets. In this replacement process, when the adjacent area is X or more, it is impossible to make a break there and move. When the area is divided by a power of 2 so as to satisfy the alignment condition, it becomes possible to always make a break at the border of 2X and to perform replacement.

From one viewpoint, the process in FIG. 9 is a process to move the unused area 503 to the position of the unallocated area 501. From another viewpoint, the process in FIG. 9 is a process to obtain the unallocated area 506 that includes 2X consecutive sets by moving the unallocated area 501 to the position of the used area 503.

The process for putting unallocated areas together by the control unit is performed using the interval between the executions of memory access instructions by the processor. When data in the processing-target area are replaced during the copying, the control unit may perform a process to store updated information in the main storage apparatus and to forward only the updated portion later to the copy-destination area.

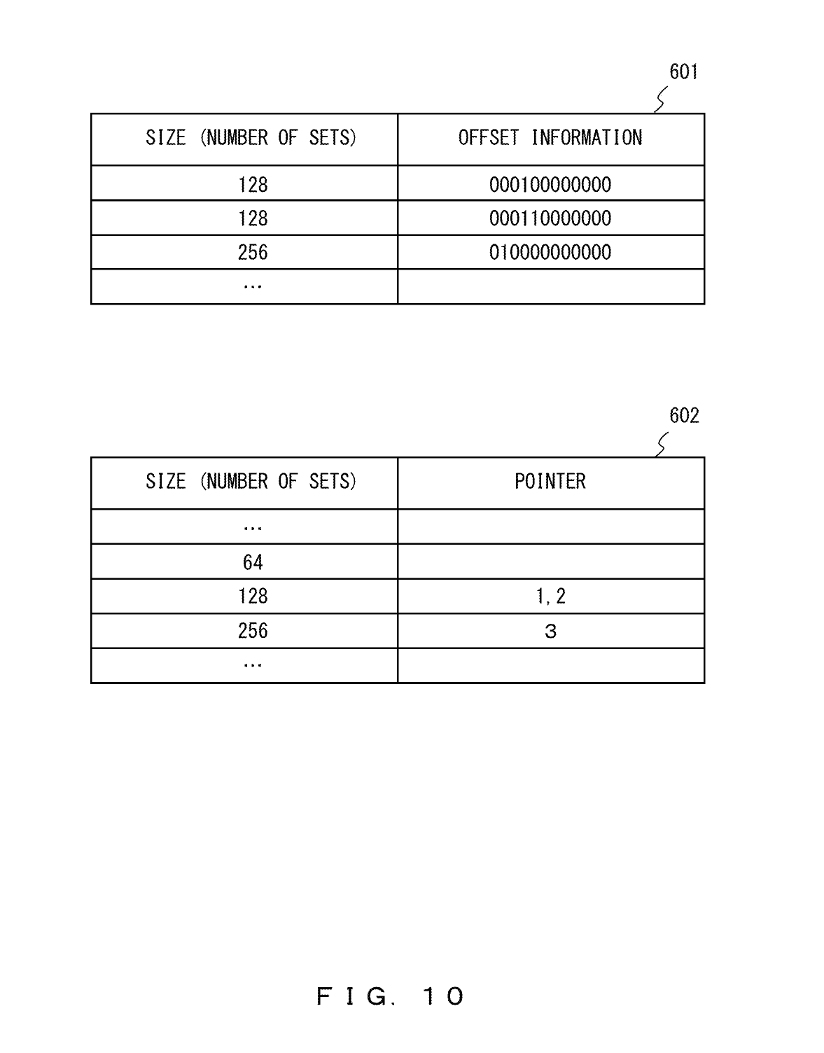

FIG. 10 illustrates an example of unallocated area information and unallocated area count information. Unallocated area information 601 and unallocated area count information 602 are information that is used by the control unit and that is stored in the main storage apparatus. The unallocated area information 601 is information of unallocated areas in a cache memory area made into a list. The unallocated area information 601 includes the size (number of sets) and offset information for each unallocated area. The offset information in the unallocated area information 601 is 12-bit information that represents the set index indicating the first set of each unallocated area. Meanwhile, an entry (that is, a pair of the size and the offset information) in the unallocated area information 601 is sorted in ascending order of the set index indicating the offset. For example, the unallocated area information 601 indicates that 128 sets starting from the set indicated by the set index “000110000000” are an unallocated area.

The unallocated area count information 602 includes information of a pointer assigned in the unallocated area information 601 for each size (number of sets) of unallocated areas, in association with the unallocated area of the corresponding size. The unallocated area information 601 includes two entries about unallocated areas that include 128 sets, and one entry about an unallocated area that includes 256 sets. Therefore, the pointer in unallocated area count information 602 corresponding to the unallocated area with 128 sets includes information that indicates the first and second entries from the beginning of the unallocated area information 601. Accordingly, it is understood that two unallocated areas with 128 sets exist in the cache memory area, and the first and second unallocated areas in the unallocated areas in the cache memory area are the unallocated areas with 128 sets. The pointer maybe information in another format such as binary notation, and identification information may be assigned to each unallocated area in the cache memory area. Meanwhile, it is preferable that there be many unallocated areas such as the unallocated area including 256 sets that may be divided into blocks of 128 sets.

In a cache memory area in which there are four nonconsecutive available areas that include 128 sets, four blocks including 128 sets maybe secured. However, in a cache memory area in which there are only four nonconsecutive available areas that all include 128 sets, it is impossible to secure any blocks including 256 sets. Meanwhile, in a cache memory area in which there are two unallocated areas that include 128 sets and one unallocated area that include 256 sets, four blocks including 128 sets may be secured. In addition, in a cache memory area in which there are two unallocated areas that include 128 sets and one unallocated area that includes 256 sets, it is also possible to secure one block including 256 sets.

As described above, the existence of one allocated area that includes 256 sets is more preferable than the existence of two nonconsecutive available areas which each include 128 sets. Therefore, the control unit calculates the number of sets in each unallocated area that is obtained under an assumption of “moving the areas as illustrated in FIG. 9”. More specifically, this assumption is an assumption of “moving one of the unused areas (the position of the unallocated area 501 for example) in the cache memory area to a position adjacent to one of the other unused areas (the position of the used area 503 for example)”. For the sake of convenience of explanation, the unallocated area obtained under this assumption is also referred to as a “consecutive available area”. For example, in the example in FIG. 9, the unallocated area 506 that includes 2X consecutive sets is the consecutive available area obtained under this assumption. The number of obtained consecutive available areas may be one or more. The control unit calculates the number of sets (2X in the example in FIG. 9 for example) included in each consecutive available area obtained under this assumption.

The control unit further obtains the “number of securable blocks” for at least respective sectors that include different numbers of sets. The number of securable blocks for a certain sector is a value obtained by dividing the number of sets calculated as described above for the consecutive available area (that is, the unallocated area) by the quotient according to a prescribed value (specifically, the number of divisions) for the number of sets included in the sector.

For example, it is assumed that there is a possibility that a sector including 2^{M} will be created in the future, and that the number of divisions is 2^{D}, and that the number of sets in a given consecutive available area is Y. In this case, each block of the sector is to include (2^{M}/2^{D}) sets. Accordingly, as long as there is a consecutive available area that includes Y sets, it is possible to secure Y/(2^{M}/2^{D}) blocks for the sector. Therefore, the number of securable blocks calculated for a combination of the consecutive available area including Y sets with a sector including 2^{M} sets is Y/(2^{M}/2^{D}).

The control unit calculates the number of securable blocks as described above. Then, the control unit moves one of the unused areas (that is, the unallocated areas) to a position adjacent to one of other unused areas, according to the total of the numbers of securable blocks for the respective consecutive available areas. More specifically, it is preferable that the control unit perform the process for putting unallocated areas together so as to maximize the total numbers of securable blocks. That is, when it is possible that only one consecutive available area will be created under the assumption mentioned above, the control unit moves an unallocated area so as to obtain this consecutive available area. Meanwhile, when it is possible that two or more consecutive available areas of different sizes will be obtained under the assumption mentioned above, the control unit calculates the total value of the numbers of securable blocks for each size of the consecutive available area (that is, a plurality of total values calculated respectively for a plurality of sectors of different sizes). Then, the control unit selects the consecutive available area with the largest total value and moves the unallocated area so as to obtain the selected consecutive available area.

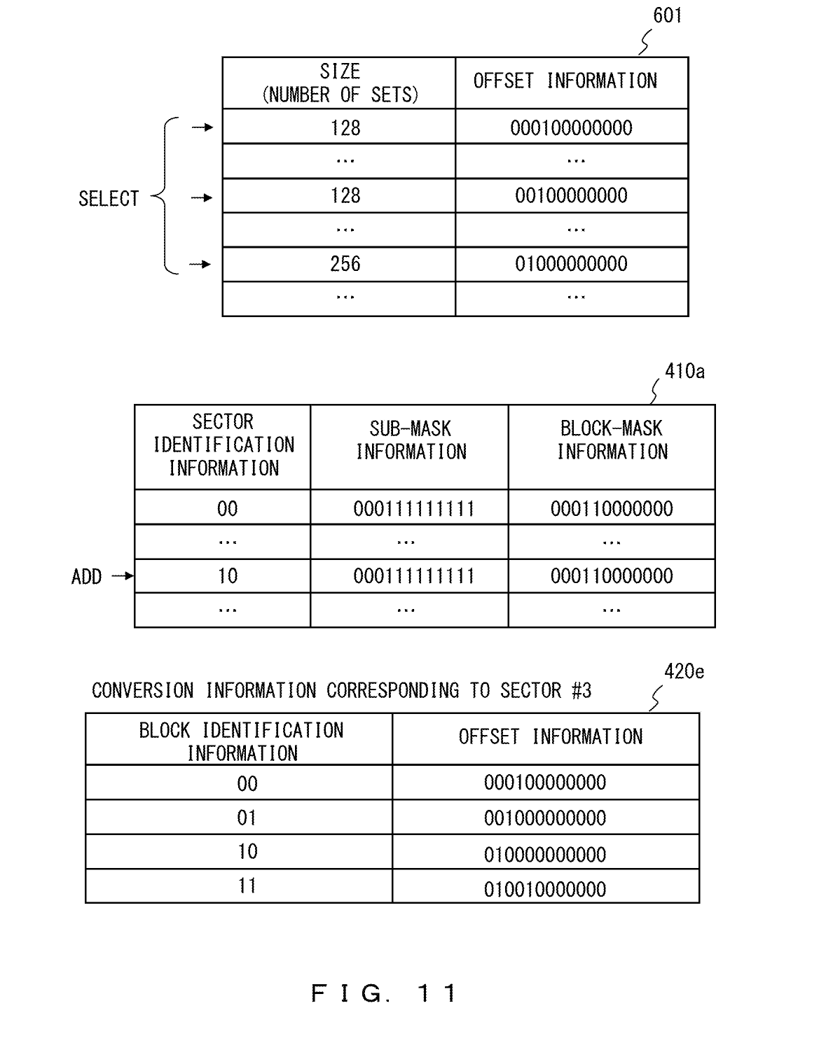

FIG. 11 illustrates an example of a sector acquisition process. The sector acquisition process is executed in the control unit, triggered by a system call called from software that runs on the computer such as a server or by an instruction from a module that is different from the control unit in the program modules included in the OS. Hereinafter, the system call and the instruction that trigger the sector acquisition process are also referred to as a “sector acquisition instruction”. The sector acquisition instruction includes, for example, size information for setting the data area of 1000 kilobytes (kB) for the sector #3.

The control unit first converts the size information included in the sector acquisition instruction into the number of sets. For example, when the cache memory area includes 10 cache ways and one cache line is 256 bytes, the size of one set is 2560 bytes. Accordingly, in order to secure a data area of 1000 kilobytes (kB), the control unit determines whether or not there are unallocated areas of 391 sets.

Here, the control unit selects α areas that are provided with n/α sets or more, where n/α is obtained by dividing, by the number of divisions “α”, the number of sets “n” for the data area desired to be secured. For example, when the number of sets of the data areas desired to be secured is 391 (n=391) and the number of divisions is 4 (α=4), n divided by α gives about 98 sets. The control unit selects from the cache memory area four unallocated areas that include 98 sets or more. As a more specific example, the control unit refers to unallocated area information 601, and selects two unallocated areas with 128 sets and one unallocated area with 256 sets. Meanwhile, the unallocated area with 256 sets maybe used as two unallocated areas with 128 sets. In addition, the number of divisions “α” is a value that represents how many blocks the sector is divided into, which is the number of divisions 2^{D} mentioned earlier. The number of divisions “α” is set in advance.

The control unit deletes the entries related to the selected unallocated areas from the unallocated area information 601. Next, the control unit updates the conversion information 410 and the conversion information 420 in FIG. 7 as described below. Meanwhile, conversion information 410a in FIG. 11 is information obtained by the execution of the sector acquisition process by the control unit, and its content is partly different from that of the conversion information 410 in FIG. 7. Meanwhile, conversion information 420e in FIG. 11 is information obtained by the execution of the sector acquisition process by the control unit, and its content is partly different from that of the conversion information 430c that corresponds to the sector #3 in FIG. 7. In addition, the content of the unallocated area information 601 in FIG. 11 is partly different from that of the unallocated area information 601 in FIG. 10.

The control unit adds to the conversion information 410a an entry that includes “10” as sector identification information that represents the sector #3 specified by the sector acquisition instruction. Meanwhile, in the example described above, the sector acquisition instruction is an instruction for obtaining 391 sets. The relative set index 314 in the area that includes 391 sets may be expressed in 9 digits, according to 2⁸<391<2⁹. Therefore, the control unit sets “000111111111” as the sub-mask information (12-digit information) for the sector #3, as illustrated in the conversion information 410a. In the sub-mask information (12-digit information), the lower 9 digits correspond to the relative set index 314.

Accordingly, 1 is set in the lower 9 digits of the 12 digits of the sub-mask information corresponding to the sector #3. The control unit sets “000110000000” as the block-mask information for the sector #3, as illustrated in the conversion information 410a. This is because the number of divisions “α” is 4. In the first 2 bits of the lower 9 digits of the block-mask information used for the calculation with the relative set index 314, “11” corresponding to the number of divisions 4 is set.

The control unit further causes the conversion information storing unit 220a to store the conversion information 420e corresponding to the sector #3. The conversion information 420e is set according to the unallocated area information 601. In the conversion information 420e, as information corresponding to the two unallocated areas with 128 sets recorded in the unallocated area information 601, block identification information “00” and “01” are assigned. As the offset information for each of the two unallocated areas with 128 sets, the same offset information as the offset information in the unallocated area information 601 is set. The unallocated area with 256 sets is used as two consecutive available areas with 128 sets. Accordingly, in the conversion information 420e, block identification information “10” and “11” are assigned in association with the unallocated area with 256 sets. As the offset information corresponding to the block identification information “10”, the offset information of the unallocated area with 256 sets is set. Meanwhile, corresponding to the block identification information “11”, the set index recorded in the unallocated area information 601 that indicates the first set of the second block in the unallocated area with 256 sets divided by 2 is set as offset information.

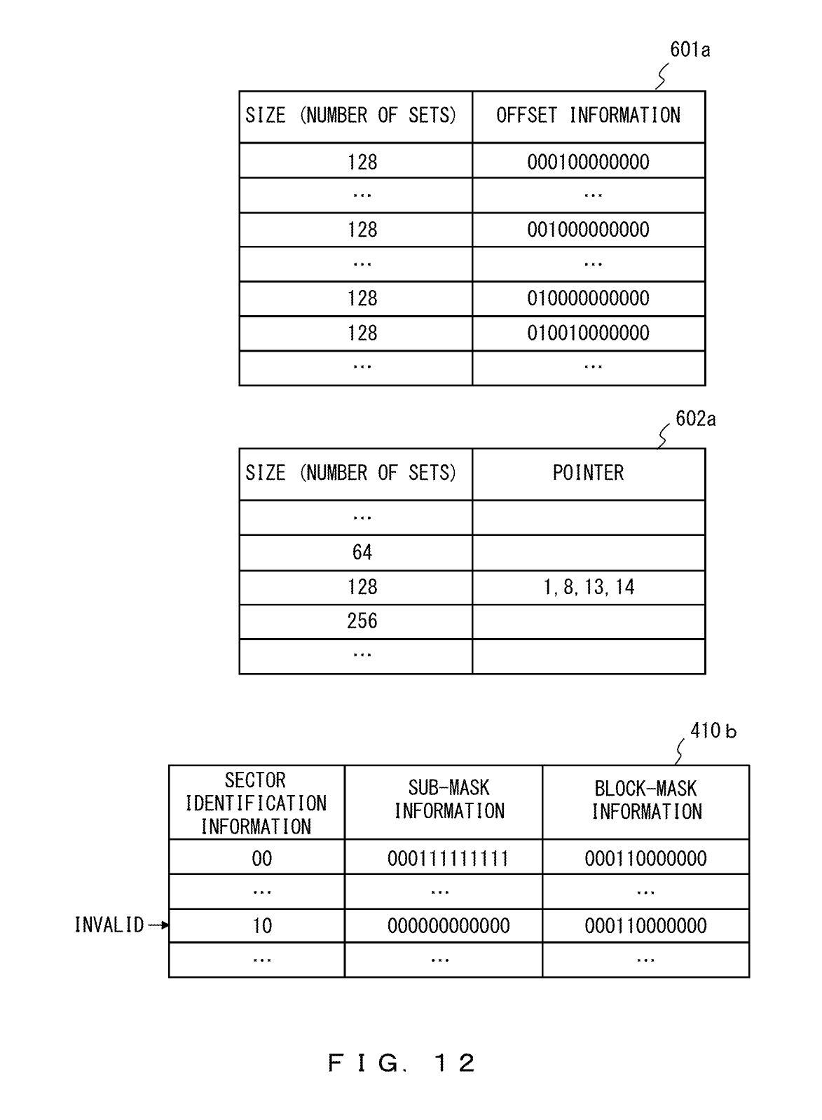

FIG. 12 illustrates an example of a sector release process. The sector release process is executed in the control unit triggered by a system call called from software that runs on the computer such as a server and by an instruction from a module that is different from the control unit in the program modules included in the OS. Hereinafter, the system call and the instruction that trigger the sector release process are also referred to as a “sector release instruction”. The sector release instruction includes information related to the sector to be the release target.

Unallocated area information 601a in FIG. 12 represents information after the unallocated area information 601 is updated by the sector release process. That is, the unallocated area information 601a is an example of information after updating in a case in which a sector acquired by the method explained with reference to FIG. 11 is released. The sector #3 to be released by the control unit includes four blocks, and each of the four blocks includes 128 sets. Information related to the four blocks is included in the conversion information 420e in FIG. 11 corresponding to the sector #3. The control units add the information of blocks to be released as illustrated in the unallocated area information 601a, according to the conversion information 420e corresponding to the sector #3. The information of blocks written into the unallocated area information 601a is the offset information for the four blocks with 128 sets. That is, in accordance with the release of the four blocks, the control unit adds four entries, as illustrated in the unallocated area information 601a.

The unallocated area count information 602a in FIG. 12 is information obtained by the execution of the sector release process by the control unit. The control unit updates, in the unallocated area count information 602a, information of pointers assigned in the unallocated area information 601 in association with the respective released blocks. Specifically, when the sector #3 is to be released, four blocks with 128 sets area released. Accordingly, the control unit writes information of the four pointers corresponding to the four blocks recorded in the unallocated area information 601a into the unallocated area count information 602a as illustrated in FIG. 12.

The conversion information 410b in FIG. 12 represents information after the conversion information 410a in FIG. 11 is updated by the sector release process by the control unit. In the sector release process, the control unit sets a value that indicates invalidity in the sub-mask information corresponding to the sector #3 in the conversion information 410b. For example, the control units sets, in the sub-mask information corresponding to the sector #3, a value “000000000000” indicating invalidity, as illustrated in the conversion information 410b.

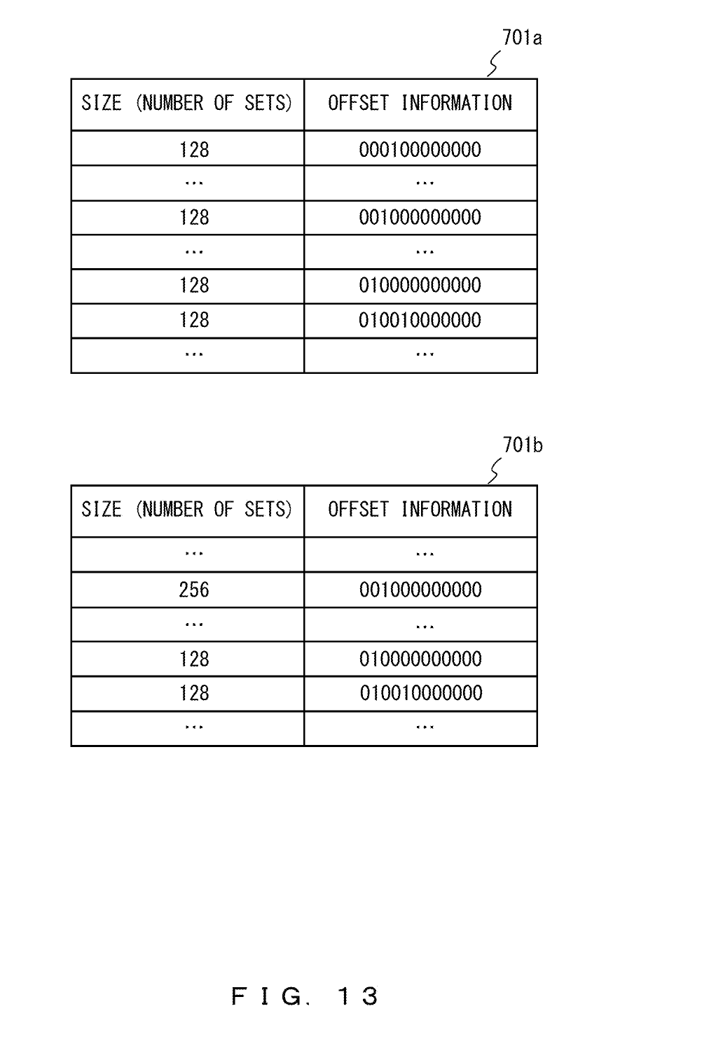

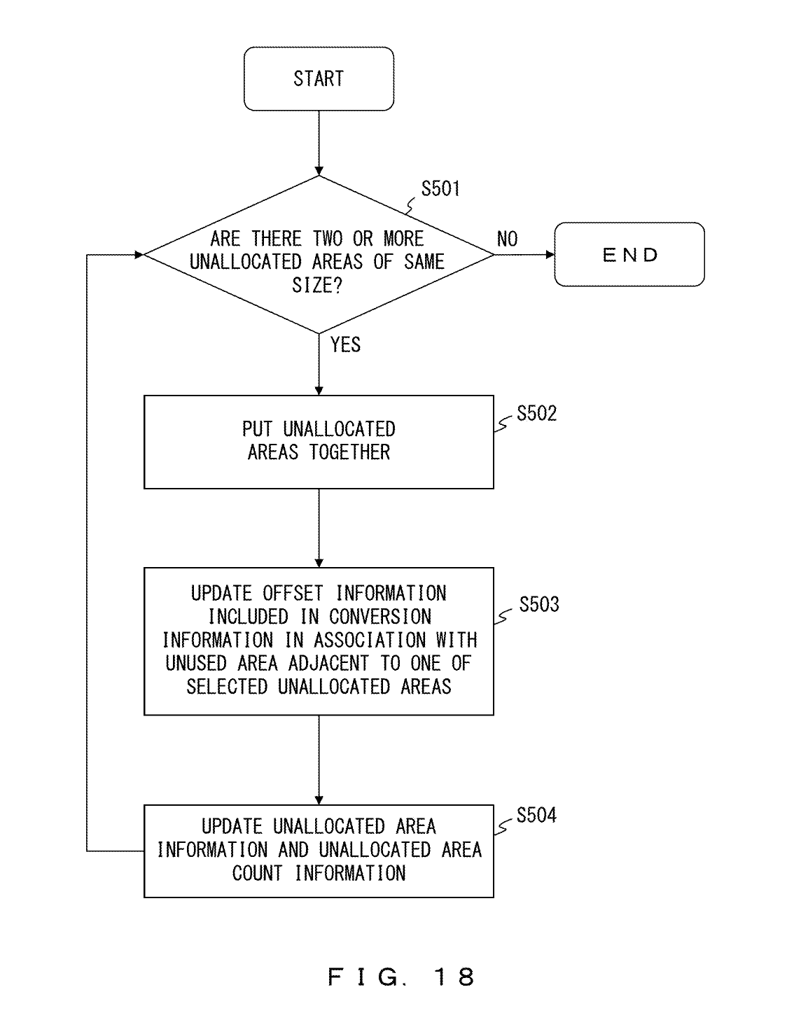

FIG. 13 illustrates an example of a process for putting unallocated areas together. The process for putting unallocated areas together (see FIG. 9 and also FIG. 18 explained later) is performed by the control unit at the end of the sector release process. Unallocated area information 701a is information representing the state of the cache memory area before the process for putting unallocated areas together is executed.

The control unit sequentially performs checks in the unallocated area information 701a from the unallocated area of a smaller size, and when there are two or more unallocated areas of the same size, it performs a process to select and put together the two unallocated areas of the same size. The unallocated area information 701a includes four entries with respect to the unallocated areas that include 128 sets. Therefore, the control unit refers to the unallocated area information 701a and performs a process to select and put together two unallocated areas that include 128 sets. As a result, as illustrated in unallocated area information 701b, an unallocated area that includes 256 is created. The control unit proceeds with checks in the unallocated area information 701a from the unallocated area of a smaller size and continues the process for putting areas together until two or more unallocated areas are no longer found.

Depending on the embodiment, the control unit may check the unallocated areas in an order that is different from the check order described above. In addition, the control unit may decide the two unallocated areas to be put together according to the total of the numbers of securable blocks as mentioned earlier, instead of deciding it according to the size-based order.

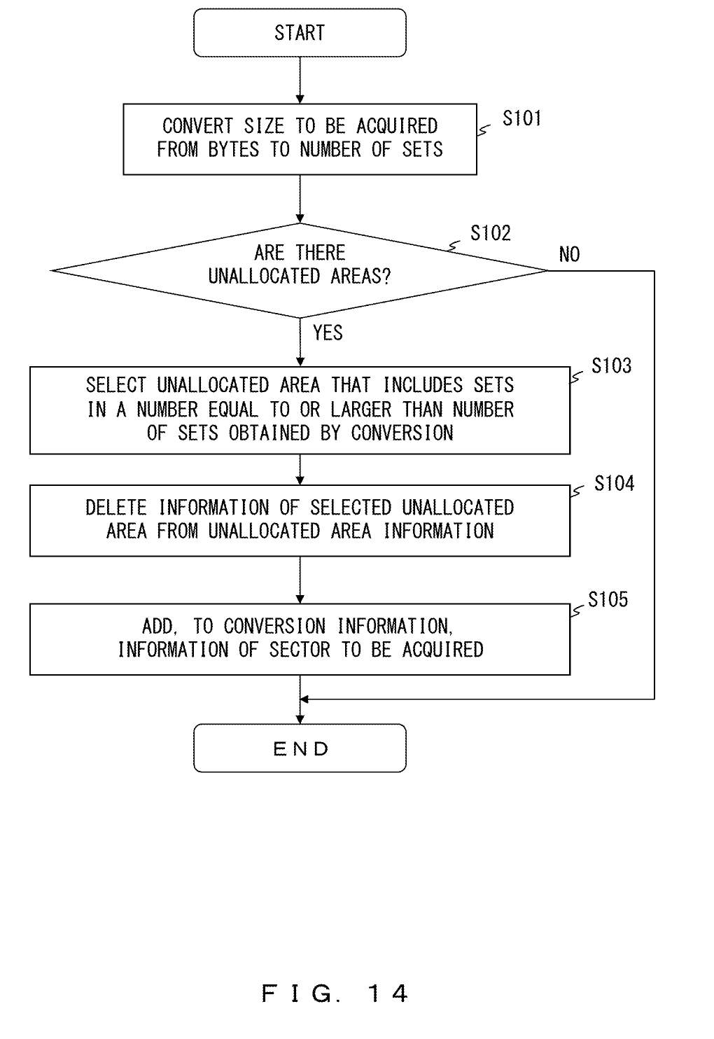

FIG. 14 is a flowchart illustrating an example (1) of the sector acquisition process. As explained regarding FIG. 11, the sector acquisition process is executed in the control unit, triggered by the sector acquisition instruction. The flowchart of the sector acquisition process illustrated in FIG. 14 is used for a cache memory that is provided with a cache memory area in which each sector is not divided into blocks (see FIG. 5 for example).

The control unit refers to the size information included in the sector acquisition instruction and converts, from the size in units of bytes to the number of sets, the size of the data area desired to be acquired (step S101). The control unit refers to the unallocated area information 601 and determines whether there are unallocated areas that include sets in a number equal to or larger than the number of sets obtained by the conversion (step S102).

When no information of unallocated areas that include sets in a number equal to or larger than the number of sets obtained by the conversion exists in the unallocated area information 601 (step S102, NO), the control unit terminates the sector acquisition process.

When information of unallocated areas that include sets in a number equal to or larger than the number of sets obtained by the conversion exists in the unallocated area information 601 (step S102, YES), the control unit selects the unallocated area that includes sets in a number equal to or larger than the number of sets obtained by the conversion (step S103). Then, the control unit deletes the information of the selected unallocated area from the unallocated area information 601 (step S104).

The control unit further adds, to the conversion information 221 in the conversion information storing unit 220, information related to the sector specified by the sector acquisition instruction (specifically, the sector identification information, the sub-mask information, and the offset information) (step S105). The sector identification information set in the entry added to the conversion information 221 in step S105 is the sector identification information specified in the sector acquisition instruction. Meanwhile, the sub-mask information set in the added entry is 12-bit information in which bits in the range corresponding to the size of the unallocated area selected in step S103 are set to “1”. In addition, the offset information set in the added entry is equal to the offset information in the entry deleted from the unallocated information 601 in step S104. When the process in step S105 is finished, the control unit terminates the sector acquisition process.

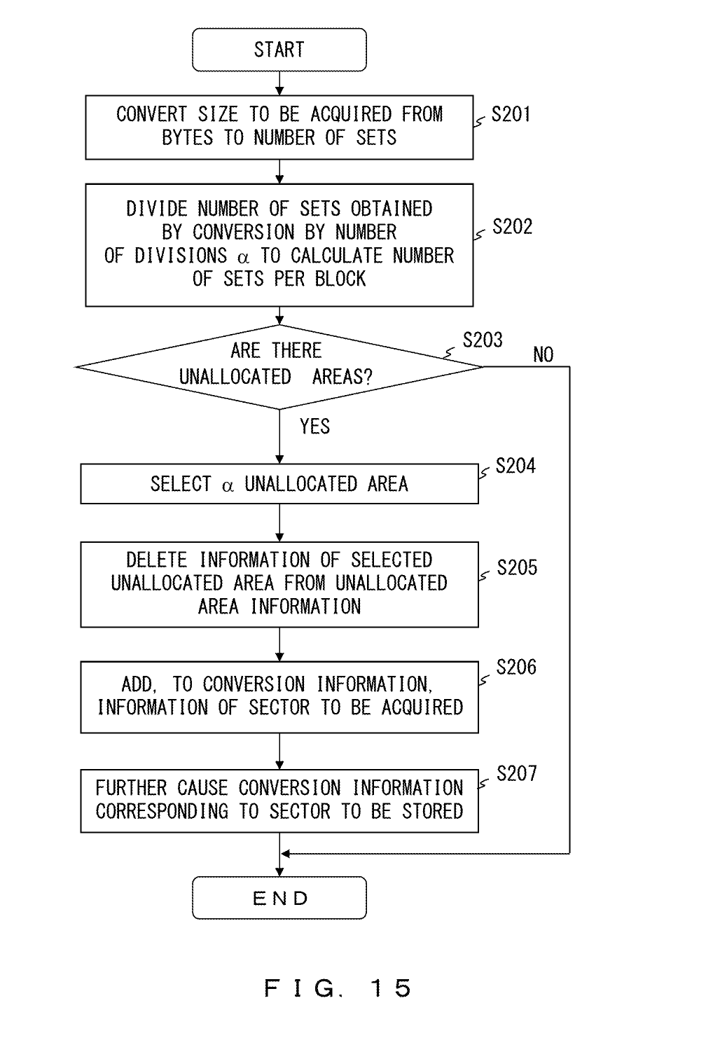

FIG. 15 is a flowchart illustrating an example (2) of the sector acquisition process. As explained regarding FIG. 11, the sector acquisition process is executed in the control unit, triggered by the sector acquisition instruction. The flowchart of the sector acquisition process illustrated in FIG. 15 is used for a cache memory that is provided with a cache memory area in which each sector may be divided and available as blocks (see FIG. 8 for example).

The control unit refers to the size information included in the sector acquisition instruction and converts the size desired to be acquired from the size in units of bytes into the number of sets (step S201). The number of sets obtained by the conversion is “n”, explained in relation to FIG. 11. The control unit divides the number of sets “n” that is the result of the conversion by the number of divisions “α” to calculate the number of sets (n/α) per block (step S202).

The control unit refers to the unallocated area information 601 and determines whether or not α unallocated areas that include sets in a number corresponding at least to the calculated number (n/α) exist (step S203) . Meanwhile, as explained in relation to FIG. 11, the control unit may regard one unallocated area that includes (nk/α) sets as k unallocated areas that include (n/α) sets (k is a natural number that is 2 or larger).

When the control unit determines that α unallocated areas that include sets in a number corresponding at least to the calculated number (n/α) do not exist as a result of the reference to the unallocated area information 601 (step S203, NO), the control unit terminates the sector acquisition process.

When the control unit determines that α unallocated areas that include sets in a number corresponding at least to the calculated number (n/α) exist as a result of reference to the unallocated area information 601 (step S203, YES), the control unit selects the α unallocated areas (step S204). The selection is based on the unallocated area information 601. Then, the control unit deletes information of each of the selected α unallocated areas from the unallocated area information 601 (step S205) .

The control unit further adds, to the conversion information 410 in the conversion information storing unit 220a, information related to the sector specified by the sector acquisition instruction (specifically, the sector identification information, the sub-mask information, and the block-mask information) (step S206). The sector information set in the entry added to the conversion information 410 in step S206 is the sector identification information specified in the sector acquisition instruction. Meanwhile, the sub-mask information set in the added entry is 12-bit information in which the bits in the range corresponding to the number of sets “n” calculated in step S201 are set to “1”. In addition, the block-mask information set in the added entry is 12-bit information in which bits in the range corresponding to the number of sets “n” and the number of divisions “α” are set to “1”.

The control unit further causes the conversion information storing unit 220a to store the conversion information 420 corresponding to the sector specified by the sector acquisition instruction (step S207). Specifically, α entries corresponding to the sector identified by the sector acquisition instruction are added. The control unit assigns block identification information to each entry. The offset information for each of the added entries is equal to the offset information in each entry deleted from the unallocated information 601 in step S205. When the process in step S207 is finished, the control unit terminates the sector acquisition process.

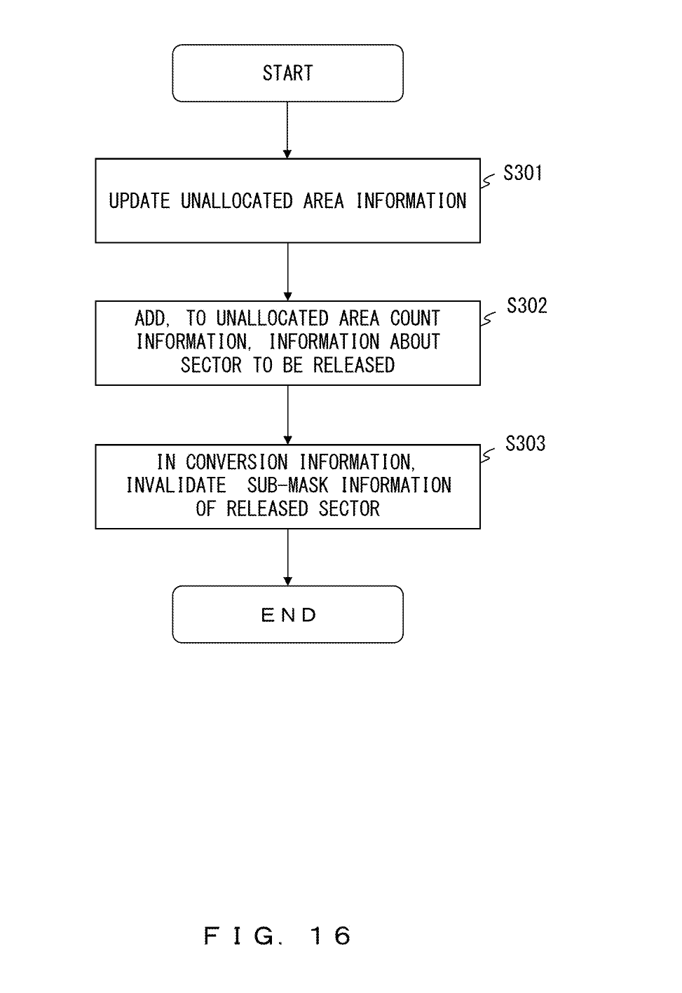

FIG. 16 is a flowchart illustrating an example (1) of the sector release process. As explained in relation to FIG. 12, the sector release process is executed in the control unit, triggered by a sector release instruction. The flowchart of the sector release process illustrated in FIG. 16 is used for a cache memory that is provided with a cache memory area in which each sector is not divided into blocks (see FIG. 5 for example).

The control unit updates the unallocated area information 601 according to the conversion information 221 corresponding to the sector specified by the sector identification information included in the sector release instruction (step S301). That is, the control unit adds, to the unallocated area information 601, an entry that includes the number of sets of the release-target sector and the offset information recorded in the conversion information 221 in association with the release-target sector.

In addition, the control unit adds, to the unallocated area count information 602, information about the sector to be released (S302). That is, the control unit adds, to the unallocated area count information 602, information of a pointer that points to the entry added in step S301.

Then, the control unit writes the value “000000000000” that indicates invalidity into the sub-mask information associated with the release-target sector in the conversion information 221 (step S303) . The control unit terminates the sector release process.

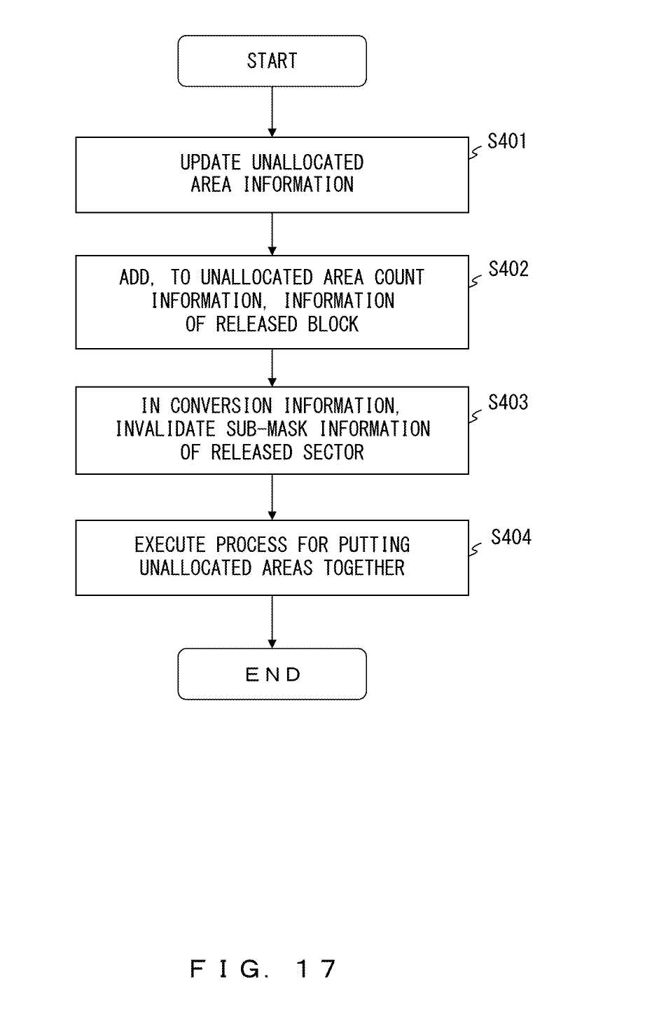

FIG. 17 is a flowchart illustrating an example (2) of the sector release process. As explained in relation to FIG. 12, the sector release process is executed in the control unit triggered by a sector release instruction. The flowchart of the sector release process illustrated in FIG. 17 is used for a cache memory that is provided with a cache memory area in which each sector may be divided and available as blocks (see FIG. 8 for example).

The control unit updates the unallocated area information 601 according to the conversion information 410 and the conversion information 420 corresponding to the sector specified by the sector identification information included in the sector release instruction (step S401) . That is, the control unit reads offset information corresponding to each block that belongs to the release-target sector from the conversion information 420, and adds, to the unallocated area information 601, a new entry including the offset information that has been read. The value of the size set in each entry to be added is the number of sets included in each block to be released. Therefore, the value of the size set in each entry to be added is determined according to the sub-mask information (that is, information that indicates the number of sets of the sector to be released) and the block-mask information (that is, information that indicates the number of divisions) in the conversion information 410.

In addition, the control unit writes, into the unallocated area count information 602, information of each pointer assigned in the unallocated area information 601 in association with each block to be released (step S402). That is, the control unit adds to the unallocated area count information 602 information of each pointer that points to each entry added in step S401.

Then, the control unit writes the value “000000000000” that indicates invalidity into the sub-mask information associated with the release-target sector in the conversion information 410 (step S403).

The control unit further starts the process for putting unallocated areas together (see FIG. 9, FIG. 13, and FIG. 18) at an appropriate timing so as not to interrupt other operations of the processor (step S404). It does not means that waiting is performed for the termination of other operations of the processor in step S404. After that, the control unit terminates the sector release process.

FIG. 18 is a flowchart illustrating an example of the process for putting unallocated areas together. The flowchart in FIG. 18 specifically illustrates the process in step S404 in the flowchart in FIG. 17.

The control unit refers to the unallocated area information 601 and determines whether the condition “there are two or more unallocated areas of the same size, and there is a used area of the same size adjacent to one of these allocated areas” is satisfied (step S501).

When the condition mentioned above is not satisfied (step S501, NO), the control unit terminates the process.

When there are two or more unallocated areas of the same size, and there is a used area of the same size adjacent to one of these unallocated areas (step S501, YES), the control unit selects the unallocated areas of the same size and performs a process for putting them together (step S502) . As explained in relation to FIG. 9, step S502 includes a process to copy the data in the used area adjacent to one of the selected unallocated areas into the other of the selected unallocated areas.

The control unit further updates the offset information included in the conversion information 420 in association with the used area adjacent to the one of the selected unallocated areas (step S503). The value after the updating is equal to the offset information included in the unallocated area information 601 in association with the other of the unallocated areas selected by the control unit.

In addition, the control unit updates the unallocated area information 601 and the unallocated area count information 602 so as to reflect the state of the blocks after the process for putting them together (step S504). The process in step S504 is described in detail below.

As a result of the process for putting unallocated areas together in FIG. 18, a used area 505 that includes 2X sets and an unallocated area 506 that includes 2X sets area created as illustrated in FIG. 9. In step S504, the control unit deletes, from the unallocated area information 601, the two entries corresponding to the two unallocated areas selected in step S502 (that is, the unallocated areas 501 and 504). Further, in step S504, the control unit adds, to the unallocated area information 601, an entry including offset information that is the set index indicating the first set of the unallocated area 506, and the size information indicating 2X. The change from the unallocated area information 701a to the unallocated area information 701b illustrated in FIG. 13 is a result of the deletion of the two entries and the addition of one entry in step S504 as described above.

In addition, in step S504, the control unit updates the entry corresponding to the number of set X and the entry corresponding to the number of sets 2X in the unallocated area count information 602. Specifically, the control unit deletes pointers corresponding to the two entries deleted from the unallocated area information 601 (that is, two pointers corresponding to the unallocated areas 501 and 504) from the entry corresponding to the number of sets X in the unallocated area count information 602. Meanwhile, the control unit writes a pointer corresponding to the entry added to the unallocated area information 601 (that is, a pointer corresponding to the unallocated area 506) into the entry corresponding to the number of sets 2X in the unallocated area count information 602. When step S504 is finished, the control unit repeats the process in FIG. 18 from step S501.

While various embodiments have been described above, the embodiments described above maybe appropriately modified. For example, the sub-mask information may be information in any format as long as it is information that represents the range of the relative set index 314. In addition, the circuits illustrated in FIG. 5 and FIG. 8 are exemplary circuits. In order to convert the relative set index 314 into an absolute set index, a circuit that is different from the circuits illustrated in FIG. 5 and FIG. 8 may be used. While some flowcharts have been presented as examples, the order of execution of steps maybe shuffled as long as there is no conflict.

In either case, by dividing the cache memory area 210 in units of sets, it becomes possible to divide the cache memory area 210 into areas that are smaller than in the case of dividing it in units of cache ways. That is, according to each of the embodiments described above, it becomes possible to divide the cache memory smaller. Accordingly, when using the cache memory area 210 in cache clear, pre-fetch, data storage processes and the like, it becomes possible to use the cache memory area 210 in units of sets whose capacity is smaller than that in units of cache ways. As a result, it becomes possible to use the cache memory area 210 more efficiently.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A cache memory comprising:
a cache memory area in which a plurality of sets, each of the plurality of sets being divided into a plurality of sectors;
a conversion information storing unit configured to store, for each of the plurality of sectors, conversion information for converting a relative set index in a sector into a set index in the cache memory area; and
a conversion circuit configured to convert the relative set index in the sector indicated by the sector identification information to a set index that indicates a set accessed by the processor in the cache memory area, based on sector identification information that identifies an access-target sector and the conversion information stored in the conversion information storing unit.

2. The cache memory according to claim 1, further comprising:
a tag information storing unit configured to store first tag information related to the cache memory area; and
a comparator circuit configured to compare the first tag information with second tag information, which is a portion of an address of a main storage apparatus other than an address that identifies data in a cache line and the relative set index in a sector.

3. The cache memory according to claim 1, wherein
the conversion information includes a first set index of each sector.

4. The cache memory according to claim 1, wherein:
at least one of the plurality of sectors is divided into a prescribed number of blocks; and
the conversion information includes a first set index of each of the prescribed number of blocks.

5. The cache memory according to claim 1, wherein
a number of sets included in each sector is a power of 2.

6. A method wherein:
when a processor attempts to execute an instruction for requesting an access to a main storage apparatus, the instruction including address information including sector identification information that identifies one of a plurality of sectors in a cache memory area in which a plurality of sets, each of the plurality of sets being divided into the plurality of sectors, the conversion circuit reads conversion information for converting a relative set index in the sector identified by the sector identification information into a set index in the cache memory area;
the conversion circuit extracts, from the address information, the relative set index in the sector identified by the sector identification information;
the conversion circuit converts the extracted relative set index in the sector identified by the sector identification information into a set index in the cache memory area using the conversion information; and
the processor accesses a set indicated by the converted set index.

7. The method according to claim 6, wherein
a comparator circuit reads first tag information related to the cache memory area from a tag information storing unit; and
the comparator circuit identifies an access-target cache line by comparing the first tag information with second tag information that is a portion of the address information other than an address that identifies data in a cache line and the relative set index in the sector.

8. The method according to claim 6, wherein
the conversion information includes a first set index of each sector.

9. The method according to claim 6, wherein:
at least one of the plurality of sectors is divided into a prescribed number of blocks; and
the conversion information includes a first set index of each of the prescribed number of blocks.

10. The method according to claim 6, wherein
a number of sets included in each sector is a power of 2.

11. A non-transitory computer-readable recording medium having stored therein a control program for causing a processor to execute a process, the process comprising:
calculating a number of sets included in each of one or more consecutive available areas obtained under an assumption that one of unused areas in a cache memory area in which a plurality of sets, each of the plurality of sets being divided into a plurality of sectors is moved to a position adjacent to one of other unused areas;
obtaining, for at least respective sectors that include different numbers of sets, a number of securable blocks, which is a value obtained by dividing the calculated number of sets by a quotient that is a prescribed value of the number of sets included in the corresponding sector; and
according to a total of the number of securable blocks for respective consecutive available areas, moving one of the unused areas to a position adjacent to one of the other unused areas.
